(19) United States
(12) Patent Application Publication
(10) Pub. No.: US 2024/0132757 A1
(43) Pub. Date: Apr. 25, 2024

(54) PRESSURE-SENSITIVE ADHESIVE COMPOSITION, PRESSURE-SENSITIVE ADHESIVE SHEET, METHOD FOR PRODUCING PRESSURE-SENSITIVE ADHESIVE COMPOSITION, AND METHOD FOR DETECTING PRESENCE OF WATER OR WATER VAPOR

(71) Applicant: NITTO DENKO CORPORATION, Ibaraki-shi, Osaka (JP)

(72) Inventors: Yosuke SHIMIZU, Ibaraki-shi, Osaka (JP); Sayaka YAMASHITA, Ibaraki-shi, Osaka (JP); Kyotaro YAMADA, Ibaraki-shi, Osaka (JP); Masatoshi KATO, Ibaraki-shi, Osaka (JP)

(21) Appl. No.: 18/275,947

(22) PCT Filed: Feb. 3, 2022
(86) PCT No.: PCT/JP2022/004266

§ 371 Date: Aug. 4, 2023

(30) Foreign Application Priority Data
Feb. 8, 2021 (JP) 2021-018308

(51) Int. Cl. C09J 11/04; C09J 7/38; C09J 133/08; G01N 31/22

(52) U.S. Cl. CPC C09J 11/04; C09J 7/385; C09J 133/08; G01N 31/222; C09J 2301/302; C09J 2301/408; C09J 2301/50

(57) ABSTRACT

The present invention relates to a pressure-sensitive adhesive composition including a base polymer and a material that is discolored by water or water vapor, a pressure-sensitive adhesive sheet including a pressure-sensitive adhesive layer containing the pressure-sensitive adhesive composition, a method for producing the pressure-sensitive adhesive composition, and a method for attaching the pressure-sensitive adhesive sheet to an adherend and detecting presence of the water or the water vapor in the attached location.

### TECHNICAL FIELD

The present invention relates to a pressure-sensitive adhesive composition, a pressure-sensitive adhesive sheet, a method for producing the pressure-sensitive adhesive composition, and a method for detecting presence of water or water vapor.

### BACKGROUND ART

It is required to detect whether water leaks from a gap or the like of a product in an inspection step of a production process, a cleaning step during maintenance, or the like, and to prevent the leakage of water.

In related art, a tape for detecting the water is known by applying, to a substrate of the tape, a material which is discolored by the water, such as a tape for a diaper, a submergence detecting tape for a smartphone, a mobile phone, or the like.

For example, as disclosed in Patent Literature 1, there has been a wetting detection sheet in which a color changes when wetting occurs due to water and leakage of water can be detected.

### CITATION LIST

### Patent Literature

Patent Literature 1: JP2013-011654A

### SUMMARY OF INVENTION

### Technical Problem

However, in the case of the tape including the material that is discolored by the water which is applied on the substrate, even if the tape is attached to a gap or the like of a product in which water leakage is assumed, since the tape substrate itself has a water discolorable function, the function is not exhibited unless the water flows around a leakage location and reaches the substrate. Therefore, there is a possibility that the water leakage cannot be detected accurately and promptly.

The wetting detection sheet disclosed in Patent Literature 1 is not intended to have a function of preventing the water leakage.

Therefore, an object of the present invention is to provide a pressure-sensitive adhesive composition having a water discolorable function in a pressure-sensitive adhesive itself instead of a substrate and having a water stop function and a water detection function.

### Solution to Problem

The present invention is as follows.
1. A pressure-sensitive adhesive composition including:
a base polymer; and
a material that is discolored by water or water vapor.
2. The pressure-sensitive adhesive composition according to 1, further including:
a polar solvent.
3. The pressure-sensitive adhesive composition according to 2, in which
the polar solvent contains at least one of an alcohol, a ketone, and an aromatic compound containing a nitrogen atom in a molecule.
4. The pressure-sensitive adhesive composition according to any one of 1 to 3, in which
the base polymer contains an acrylic polymer.
5. The pressure-sensitive adhesive composition according to any one of 1 to 4, in which
the material that is discolored by the water or the water vapor contains a transition metal compound capable of coordinating with a water molecule.
6. The pressure-sensitive adhesive composition according to 5, in which
the transition metal compound capable of coordinating with the water molecule is cobalt chloride.
7. A pressure-sensitive adhesive sheet including:
a pressure-sensitive adhesive layer containing the pressure-sensitive adhesive composition according to any one of 1 to 6.
8. The pressure-sensitive adhesive sheet according to 7, in which
the pressure-sensitive adhesive layer is provided on a substrate.
9. The pressure-sensitive adhesive sheet according to 7 or 8, which is configured to detect leakage of the water or the water vapor from an assumed water leakage location.
10. A method for producing a pressure-sensitive adhesive composition including a base polymer and a material that is discolored by water or water vapor, the method including:
a step of dissolving, in a polar solvent, the material that is discolored by the water or the water vapor; and
a step of adding, to a base polymer solution, the material that is discolored by the water or the water vapor which is dissolved in the polar solvent.
11. A method for attaching the pressure-sensitive adhesive sheet according to any one of 7 to 9 to an adherend and detecting presence of the water or the water vapor in the attached location.

### Advantageous Effects of Invention

A pressure-sensitive adhesive composition according to one embodiment of the present invention has a water discolorable function. Therefore, by attaching a pressure-sensitive adhesive sheet using the pressure-sensitive adhesive composition according to the present embodiment to a location where water leakage is assumed, leakage of water or water vapor from the location can be prevented, and an occurrence thereof can be easily detected. As described above, according to the pressure-sensitive adhesive composition of the present embodiment, it is possible to exhibit both a water stop function and a water detection function at the same time.

### BRIEF DESCRIPTION OF DRAWINGS

FIG. 1 is an example of a schematic cross-sectional view of a pressure-sensitive adhesive layer according to an embodiment of the present invention.

FIG. 2 is an example of a schematic cross-sectional view of a pressure-sensitive adhesive sheet according to an embodiment of the present invention.

FIG. 3 is an example of a schematic cross-sectional view of a pressure-sensitive adhesive sheet according to an embodiment of the present invention.

### DESCRIPTION OF EMBODIMENTS

In present specification, “A to B” indicating a range means “A or more and B or less”. Further, in the present specification, “weight”, “mass”, “% by weight”, “% by mass”, “parts by weight”, and “parts by mass” are treated as synonyms.

In the present specification, a “pressure-sensitive adhesive” refers to a material that exhibits a soft solid (viscoelastic) state in a temperature range around room temperature and has a property of easily adhering to an adherend under pressure. The pressure-sensitive adhesive referred to herein may be a material generally having a property satisfying a complex tensile modulus E* (1 Hz)<10⁷ dyne/cm² (typically, a material having the above-mentioned property at 25° C.) as defined in “C. A. Dahlquist, “Adhesion: Fundamentals and Practice”, McLaren & Sons, (1966) P. 143”.

Hereinafter, an embodiment of the present invention will be described in detail. The present invention is not limited to the embodiments to be described below.

<Pressure-Sensitive Adhesive Composition>

A pressure-sensitive adhesive composition according to one embodiment of the present invention contains a base polymer and a material that is discolored by water or water vapor.

Components contained in the pressure-sensitive adhesive composition will be described in detail below.

(Base Polymer)

In the pressure-sensitive adhesive composition according to this aspect, the base polymer constituting the pressure-sensitive adhesive composition is not particularly limited, and a known polymer used in the pressure-sensitive adhesive can be used.

Examples of the base polymer include an acrylic polymer, a rubber-based polymer, a vinyl alkyl ether-based polymer, a silicone-based polymer, a polyester-based polymer, a polyamide-based polymer, a urethane-based polymer, a fluorine-based polymer, and an epoxy-based polymer. Among them, an acrylic polymer or a rubber-based polymer is preferable from the viewpoint of adhesiveness. Further, an acrylic polymer having high transparency is more preferable from the viewpoint of making a change in appearance significant when the pressure-sensitive adhesive layer is discolored. These polymers may be used alone or in combination of two or more kinds thereof.

Hereinafter, an aspect in which the pressure-sensitive adhesive composition according to one embodiment of the present invention contains the acrylic polymer as the base polymer will be mainly described, but the present invention is not limited to this aspect.

The pressure-sensitive adhesive composition according to one embodiment of the present invention may contain the acrylic polymer as the base polymer. Typically, the pressure-sensitive adhesive composition may be an acrylic pressure-sensitive adhesive composition containing the acrylic polymer as a main component. The acrylic pressure-sensitive adhesive composition is excellent in transparency.

The pressure-sensitive adhesive composition according to one embodiment of the present invention preferably contains, as the base polymer, an acrylic polymer constituted by a monomer component containing, for example, 40% by weight or more of a (meth)acrylic acid alkyl ester having a linear or branched alkyl group having 1 to 20 carbon atoms at an ester terminal.

Hereinafter, the (meth)acrylic acid alkyl ester having an alkyl group having X or more and Y or less carbon atoms at the ester terminal may be referred to as a “C_{X-Y} (meth)acrylic acid alkyl ester”.

In order to easily balance properties, a proportion of a C₁₋₂₀ (meth)acrylic acid alkyl ester in total monomer components of the acrylic polymer according to one aspect is suitably more than 50% by weight, and may be, for example, 55% by weight or more, 60% by weight or more, or even 70% by weight or more. For the same reason, the proportion of the C₁₋₂₀ (meth)acrylic acid alkyl ester in the monomer components may be, for example, 99.9% by weight or less, 99.5% by weight or less, or 99% by weight or less.

A proportion of the C₁₋₂₀ (meth)acrylic acid alkyl ester in the total monomer components of the acrylic polymer according to another aspect may be, for example, 98% by weight or less, and may be 95% by weight or less, 85% by weight or less (for example, less than 80% by weight), 70% by weight or less, or 60% by weight or less from the viewpoint of improving cohesiveness of the pressure-sensitive adhesive layer.

Non-limiting specific examples of the C₁₋₂₀ (meth)acrylic acid alkyl ester include methyl (meth)acrylate, ethyl (meth)acrylate, propyl (meth)acrylate, isopropyl (meth)acrylate, n-butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, stearyl (meth)acrylate, isostearyl (meth)acrylate, nonadecyl (meth)acrylate, and eicosyl (meth)acrylate.

Among these, at least a C₄₋₂₀ (meth)acrylic acid alkyl ester is preferably used, and a C₄₋₁₈ (meth)acrylic acid alkyl ester is more preferably used.

For example, it is preferable that the monomer components contain one or both of n-butyl acrylate (BA) and 2-ethyl hexyl acrylate (2EHA).

Other examples of the C₄₋₂₀ (meth)acrylic acid alkyl ester that may be preferably used include isononyl acrylate, n-butyl methacrylate (BMA), 2-ethylhexyl methacrylate (2EHMA), and isostearyl acrylate (iSTA).

In some aspects, the monomer components constituting the acrylic polymer may contain a C₄₋₁₈ (meth)acrylic acid alkyl ester in a proportion of 40% by weight or more. The proportion of the C₄₋₁₈ (meth)acrylic acid alkyl ester in the monomer components may be, for example, 50% by weight or more, 60% by weight or more, or 65% by weight or more. The monomer components may be monomer components containing a C₆₋₁₈ (meth)acrylic acid alkyl ester in a proportion equal to or greater than any one of the above-described lower limit values.

From the viewpoint of enhancing the cohesiveness of the pressure-sensitive adhesive layer, the proportion of the C₄₋₁₈ (meth)acrylic acid alkyl ester in the monomer components is usually suitably 99.5% by weight or less, 95% by weight or less, 85% by weight or less, or 75% by weight or less. The monomer components may be monomer components containing the C₆₋₁₈ (meth)acrylic acid alkyl ester in a proportion equal to or less than any one of the above-described upper limits.

The monomer components constituting the acrylic polymer may contain another monomer (copolymerizable monomer) which is copolymerizable with the (meth)acrylic acid alkyl ester as necessary, together with the (meth)acrylic acid alkyl ester.

As the copolymerizable monomer, for example, a monomer having a polar group such as a carboxy group, a hydroxyl group, or a nitrogen atom-containing ring, or a monomer having a relatively high glass transition temperature of a homopolymer (for example, 10° C. or higher) can be appropriately used. The monomer having the polar group may be useful for introducing a crosslinking point into the acrylic polymer or increasing cohesive force of the pressure-sensitive adhesive. The copolymerizable monomer may be used alone or in combination of two or more kinds thereof.

Non-limiting specific examples of the copolymerizable monomer include the following monomers.

Carboxy group-containing monomer: for example, acrylic acid, methacrylic acid, carboxyethyl acrylate, carboxypentyl acrylate, itaconic acid, maleic acid, fumaric acid, crotonic acid, and isocrotonic acid.

Acid anhydride group-containing monomer: for example, maleic anhydride and itaconic acid anhydride.

Hydroxyl group-containing monomer: for example, hydroxyalkyl (meth)acrylate such as 2-hydroxyethyl (meth)acrylate, 2-hydroxypropyl (meth)acrylate, 2-hydroxybutyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)methyl (meth)acrylate.

Monomer containing a sulfonate group or a phosphate group: for example, styrenesulfonic acid, allylsulfonic acid, sodium vinylsulfonate, 2-(meth)acrylamide-2-methylpropanesulfonic acid, (meth)acrylamide propanesulfonic acid, sulfopropyl (meth)acrylate, (meth)acryloyloxynaphthalenesulfonic acid, and 2-hydroxyethyl acryloyl phosphate.

Epoxy group-containing monomer: for example, epoxy group-containing acrylates such as glycidyl (meth)acrylate and (meth)acrylic acid-2-ethyl glycidyl ether, allyl glycidyl ether, and (meth)acrylic acid glycidyl ether.

Cyano group-containing monomer: for example, acrylonitrile and methacrylonitrile.

Isocyanate group-containing monomer: for example, 2-isocyanatoethyl (meth)acrylate.

Amide group-containing monomer: for example, (meth)acrylamide; N,N-dialkyl(meth)acrylamides such as N,N-dimethyl(meth)acrylamide, N,N-diethyl(meth)acrylamide, N,N-dipropyl(meth)acrylamide, N,N-diisopropyl(meth)acrylamide, N,N-di(n-butyl)(meth)acrylamide, and N,N-di(t-butyl)(meth)acrylamide; N-alkyl(meth)acrylamides such as N-ethyl(meth)acrylamide, N-isopropyl(meth)acrylamide, N-butyl(meth)acrylamide, and N-n-butyl(meth)acrylamide; N-vinyl carboxylic acid amides such as N-vinylacetamide; monomers having a hydroxyl group and an amide group, for example, N-hydroxyalkyl(meth)acrylamides such as N-(2-hydroxyethyl)(meth)acrylamide, N-(2-hydroxypropyl)(meth)acrylamide, N-(1-hydroxypropyl)(meth)acrylamide, N-(3-hydroxypropyl)(meth)acrylamide, N-(2-hydroxybutyl)(meth)acrylamide, N-(3-hydroxybutyl)(meth)acrylamide, and N-(4-hydroxybutyl)(meth)acrylamide; monomers having an alkoxy group and an amide group, for example, N-alkoxyalkyl(meth)acrylamides such as N-methoxymethyl(meth)acrylamide, N-methoxyethyl(meth)acrylamide, and N-butoxymethyl(meth)acrylamide; and N,N-dimethylaminopropyl(meth)acrylamide and N-(meth)acryloylmorpholine.

Amino group-containing monomer: for example, aminoethyl (meth)acrylate, N,N-dimethylaminoethyl (meth)acrylate, and t-butylaminoethyl (meth)acrylate.

Monomer having an epoxy group: for example, glycidyl (meth)acrylate, methylglycidyl (meth)acrylate, and allyl glycidyl ether.

Monomer having a nitrogen atom-containing ring: for example, N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinylmorpholine, N-vinyl-3-morpholine, N-vinyl-2-caprolactam, N-vinyl-1,3-oxazine-2-one, N-vinyl-3,5-morpholinedione, N-vinylpyrazole, N-vinylisoxazole, N-vinylthiazole, N-vinylisothiazole, and N-vinylpyridazine (for example, lactams such as N-vinyl-2-caprolactam).

Monomer having a succinimide skeleton: for example, N-(meth)acryloyloxymethylenesuccinimide, N-(meth)acryloyl-6-oxyhexamethylenesuccinimide, and N-(meth)acryloyl-8-oxyhexamethylenesuccinimide

Maleimides: for example, N-cyclohexylmaleimide, N-isopropylmaleimide, N-laurylmaleimide, and N-phenylmaleimide.

Itaconimides: for example, N-methylitaconimide, N-ethylitaconimide, N-butylitaconimide, N-octylitaconimide, N-2-ethylhexylitaconimide, N-cyclohexylitaconimide, and N-laurylitaconimide

Aminoalkyl (meth)acrylates: for example, aminoethyl (meth)acrylate, N,N-dimethylaminoethyl (meth)acrylate, N,N-diethylaminoethyl (meth)acrylate, and t-butylaminoethyl (meth)acrylate.

Alkoxy group-containing monomers: for example, alkoxyalkyl (meth)acrylates (alkoxyalkyl (meth)acrylates) such as 2-methoxyethyl (meth)acrylate, 3-methoxypropyl (meth)acrylate, 2-ethoxyethyl (meth)acrylate, propoxyethyl (meth)acrylate, butoxyethyl (meth)acrylate, and ethoxypropyl (meth)acrylate; and alkoxyalkyleneglycol (meth)acrylates (for example, alkoxypolyalkyleneglycol (meth)acrylates) such as methoxyethyleneglycol (meth)acrylate, methoxypolyethyleneglycol (meth)acrylate, and methoxypolypropyleneglycol (meth)acrylate.

Monomer containing alkoxysilyl group: for example, alkoxysilyl group-containing (meth)acrylates such as 3-(meth)acryloxypropyltrimethoxysilane, 3-(meth)acryloxypropyltriethoxysilane, 3-(meth)acryloxypropylmethyldimethoxysilane, and 3-(meth)acryloxypropylmethyldiethoxysilane, and alkoxysilyl group-containing vinyl compounds such as vinyltrimethoxysilane and vinyltriethoxysilane.

Vinyl esters: for example, vinyl acetate and vinyl propionate.

Vinyl ethers: for example, vinyl alkyl ethers such as methyl vinyl ether and ethyl vinyl ether.

Aromatic vinyl compounds: for example, styrene, α-methylstyrene, and vinyltoluene.

Olefins: for example, ethylene, butadiene, isoprene, and isobutylene.

(Meth)acrylic acid esters having an alicyclic hydrocarbon group: for example, alicyclic hydrocarbon group-containing (meth)acrylates such as cyclopentyl (meth)acrylate, cyclohexyl (meth)acrylate, isobornyl (meth)acrylate, dicyclopentanyl (meth)acrylate, and adamantyl (meth)acrylate.

(Meth)acrylic acid esters having an aromatic hydrocarbon group: for example, aromatic hydrocarbon group-containing (meth)acrylates such as phenyl (meth)acrylate, phenoxyethyl (meth)acrylate, and benzyl (meth)acrylate.

And heterocycle-containing (meth)acrylates such as tetrahydrofurfuryl (meth)acrylate, halogen atom-containing (meth)acrylates such as vinyl chloride and fluorine atom-containing (meth)acrylates, silicon atom-containing (meth)acrylates such as silicone (meth)acrylates, and (meth)acrylic acid esters obtained from terpenic compound derivative alcohols.

When such a copolymerizable monomer is used, a used amount thereof is not particularly limited, and is usually suitably 0.01% by weight or more based on the total monomer components.

From the viewpoint of better exhibiting an effect of using the copolymerizable monomer, the used amount of the copolymerizable monomer may be 0.1% by weight or more, or 0.5% by weight or more based on the total monomer components. From the viewpoint of facilitating the balance of adhesive properties, the used amount of the copolymerizable monomer is usually suitably 50% by weight or less, preferably 40% by weight or less based on the total monomer components.

In some aspects, the monomer components constituting the acrylic polymer may include a monomer having a nitrogen atom. Accordingly, the cohesive force of the pressure-sensitive adhesive can be increased, and peeling force after passage of time can be preferably improved. One preferable example of the monomer having a nitrogen atom is a monomer having a nitrogen atom-containing ring. As the monomer having the nitrogen atom-containing ring, those illustrated above can be used, and examples thereof include N-vinyl cyclic amides represented by the following general formula (1).

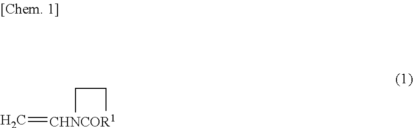

In the general formula (1), IV represents a divalent organic group, specifically —(CH₂)ₙ—. The n is an integer of 2 to 7 (preferably 2, 3, and 4). Among them, N-vinyl-2-pyrrolidone is preferably used. Other preferable examples of the monomer having a nitrogen atom include (meth)acrylamide.

A used amount of the monomer having a nitrogen atom (preferably the monomer having a nitrogen atom-containing ring) is not particularly limited, and can be, for example, 1% by weight or more, 3% by weight or more, 5% by weight or more, or 7% by weight or more based on the total monomer components.

In one aspect, the used amount of the monomer having a nitrogen atom may be 10% by weight or more, 15% by weight or more, or 20% by weight or more based on the total monomer components.

The used amount of the monomer having a nitrogen atom is suitably, for example, 40% by weight or less, and may be 35% by weight or less, 30% by weight or less, or 25% by weight or less based on the total monomer components.

In another aspect, the used amount of the monomer having a nitrogen atom may be, for example, 20% by weight or less, or 15% by weight or less based on the total monomer components.

In some aspects, the monomer components constituting the acrylic polymer may include the hydroxyl group-containing monomer. By using the hydroxyl group-containing monomer, a degree of the cohesive force and crosslinking (for example, crosslinking with an isocyanate-based crosslinking agent) of the pressure-sensitive adhesive can be appropriately adjusted.

When the hydroxyl group-containing monomer is used, a used amount thereof is not particularly limited, and may be, for example, 0.01% by weight or more, 0.1% by weight or more, 0.5% by weight or more, 1% by weight or more, 5% by weight or more, or 10% by weight or more based on the total monomer components.

From the viewpoint of reducing water absorbency of the pressure-sensitive adhesive layer, in some aspects, the used amount of the hydroxyl group-containing monomer is suitably, for example, 40% by weight or less, and may be 30% by weight or less, 25% by weight or less, or 20% by weight or less based on the total monomer components.

In another aspect, the used amount of the hydroxyl group-containing monomer may be, for example, 15% by weight or less, 10% by weight or less, or 5% by weight or less based on the total monomer components.

In the pressure-sensitive adhesive composition according to one embodiment of the present invention, the monomer components of the acrylic polymer may or may not include the alkoxyalkyl (meth)acrylate and the alkoxypolyalkyleneglycol (meth)acrylate illustrated above.

In one aspect of the technology according to the present aspect, a proportion of alkoxyalkyl (meth)acrylate in the monomer components of the acrylic polymer is less than 20% by weight, and a proportion of the alkoxypolyalkyleneglycol (meth)acrylate is less than 20% by weight. Accordingly, the pressure-sensitive adhesive layer can be easily formed into a sheet without a problem such as gelation. By adopting the above monomer composition, a desired high-molecular-weight substance (for example, a weight-average molecular weight (Mw) of more than 30×10⁴, typically Mw of 40×10⁴ or more) can be preferably polymerized by maintaining a solid content concentration of a monomer mixture within a predetermined range.

A proportion of alkoxyalkyl (meth)acrylate in the monomer components is preferably less than 10% by weight, more preferably less than 3% by weight, and still more preferably less than 1% by weight, and in a particularly preferred aspect, the monomer components do not substantially contain alkoxyalkyl (meth)acrylate (content of 0% to 0.3% by weight).

Similarly, the proportion of alkoxypolyalkyleneglycol (meth)acrylate in the monomer components is preferably less than 10% by weight, more preferably less than 3% by weight, and still more preferably less than 1% by weight, and in a particularly preferred aspect, the monomer components do not substantially contain alkoxypolyalkyleneglycol (meth)acrylate (content of 0% to 0.3% by weight).

In the monomer components of the acrylic polymer according to a preferable aspect, from the viewpoint of prevention of the gelation, a total proportion of the alkoxyalkyl (meth)acrylate and the alkoxypolyalkyleneglycol (meth)acrylate is limited to less than 20% by weight. The total proportion of alkoxyalkyl (meth)acrylate and alkoxypolyalkyleneglycol (meth)acrylate is more preferably less than 10% by weight, still more preferably less than 3% by weight, and particularly preferably less than 1% by weight, and in one aspect, the monomer components are substantially free of alkoxyalkyl (meth)acrylate and alkoxypolyalkyleneglycol (meth)acrylate (content of 0% to 0.3% by weight).

Similarly, the monomer components of the acrylic polymer according to this aspect may or may not contain the alkoxy group-containing monomer in a proportion less than 20% by weight. An amount of the alkoxy group-containing monomer in the monomer components is preferably less than 10% by weight, more preferably less than 3% by weight, and even more preferably less than 1% by weight, and in a particularly preferred aspect, the monomer components do not substantially contain the alkoxy group-containing monomer (content of 0% to 0.3% by weight).

In some aspect, a proportion of the carboxy group-containing monomer in the monomer components of the acrylic polymer may be, for example, 2% by weight or less, 1% by weight or less, or 0.5% by weight or less (for example, less than 0.1% by weight).

It is not necessary to substantially use the carboxy group-containing monomer as the monomer component of the acrylic polymer. Here, the phrase “not substantially use the carboxy group-containing monomer” means that the carboxy group-containing monomer is not used at least intentionally. The acrylic polymer having such a composition is likely to have high water resistance reliability, and can have metal corrosion resistance to the adherend containing metal.

In a preferable aspect, the monomer components of the acrylic polymer have a limited proportion of hydrophilic monomers. As used herein, the term “hydrophilic monomer” refers to the carboxy group-containing monomer, the acid anhydride group-containing monomer, the hydroxyl group-containing monomer, and the monomer having a nitrogen atom (typically, an amide group-containing monomer such as (meth)acrylamide, and a monomer having a nitrogen atom-containing ring such as N-vinyl-2-pyrrolidone), and the alkoxy group-containing monomer (typically, alkoxyalkyl (meth)acrylate and alkoxypolyalkyleneglycol (meth)acrylate).

In this aspect, the proportion of the hydrophilic monomer in the monomer components of the acrylic polymer is preferably 32% by weight or less, for example, 30% by weight or less, and may be 28% by weight or less.

Although not particularly limited, the proportion of the hydrophilic monomer in the monomer components of the acrylic polymer may be 1% by weight or more, 10% by weight or more, or 20% by weight or more.

In some aspects, the monomer components constituting the acrylic polymer may contain an alicyclic hydrocarbon group-containing (meth)acrylate. Accordingly, the cohesive force of the pressure-sensitive adhesive can be increased, and the peeling force after passage of time can be improved.

As the alicyclic hydrocarbon group-containing (meth)acrylate, those illustrated above can be used, and for example, cyclohexyl acrylate and isobornyl acrylate can be preferably used.

When the alicyclic hydrocarbon group-containing (meth)acrylate is used, a used amount thereof is not particularly limited, and can be, for example, 1% by weight or more, 3% by weight or more, or 5% by weight or more based on the total monomer components.

In one aspect, the used amount of the alicyclic hydrocarbon group-containing (meth)acrylate may be 10% by weight or more, or 15% by weight or more based on the total monomer components.

An upper limit of the used amount of the alicyclic hydrocarbon group-containing (meth)acrylate is suitably about 40% by weight or less, and may be, for example, 30% by weight or less, or 25% by weight or less (for example, 15% by weight or less, further 10% by weight or less).

A composition of the monomer components constituting the acrylic polymer may be set such that a glass transition temperature Tg obtained from a Fox equation based on the compositions of the monomer components is −75° C. or higher and 10° C. or lower.

In some aspects, from the viewpoint of the cohesiveness, impact resistance, and the like, the above Tg is suitably 0° C. or less, preferably −10° C. or less, and may be −20° C. or less or −30° C. or less. Further, the Tg may be, for example, −60° C. or higher, −50° C. or higher, and −45° C. or higher, or −40° C. or higher.

Here, the Fox equation is a relational expression between Tg of a copolymer and a glass transition temperature Tgi of a homopolymer obtained by homopolymerizing each of monomers constituting the copolymer, as shown below.

1/Tg=Σ(Wi/Tgi)

In the Fox equation, Tg represents the glass transition temperature (unit: K) of the copolymer, Wi represents a weight fraction (copolymerization ratio based on a weight) of a monomer i in the copolymer, and Tgi represents the glass transition temperature (unit: K) of the homopolymer of the monomer i.

The glass transition temperature of the homopolymer used for calculation of Tg is a value described in a known document. For example, in the following monomers, the following values are used as the glass transition temperature of the homopolymer of the monomer.
2-ethylhexyl acrylate −70° C.
n-butyl acrylate −55° C.
Isostearyl acrylate −18° C.
Methyl methacrylate 105° C.
Methylacrylate 8° C.
Cyclohexyl acrylate 15° C.
N-vinyl-2-pyrrolidone 54° C.
2-hydroxyethyl acrylate −15° C.
4-hydroxybutyl acrylate −40° C.
Dicyclopentanyl methacrylate 175° C.
Isobornyl acrylate 94° C.
Acrylic acid 106° C.
Methacrylic acid 228° C.

For a glass transition temperature of a homopolymer of a monomer other than those illustrated above, a numerical value described in “Polymer Handbook” (3rd edition, John Wiley & Sons, Inc., 1989) is used. When a plurality of types of values are described in this document, a highest value is adopted.

For a monomer in which a glass transition temperature of a homopolymer is not described in the above Polymer Handbook, a value obtained by the following measurement method is be used (see JP2007-51271A).

Specifically, 100 parts by weight of a monomer, 0.2 parts by weight of azobisisobutyronitrile, and 200 parts by weight of ethyl acetate as a polymerization solvent are added to a reaction vessel equipped with a thermometer, a stirrer, a nitrogen introduction pipe, and a reflux condenser, and a mixture is stirred for 1 hour while allowing nitrogen gas to flow. After oxygen in a polymerization system is removed in this manner, a temperature is raised to 63° C. and reaction is performed for 10 hours.

Next, the mixture is cooled to room temperature to obtain a homopolymer solution having a solid content concentration of 33% by weight. Next, this homopolymer solution is cast and coated on a release liner and the release liner is dried to prepare a test sample (sheet-shaped homopolymer) having a thickness of about 2 mm

This test sample is punched into a disk shape having a diameter of 7.9 mm, sandwiched by parallel plates, and subjected to shear strain at a frequency of 1 Hz using a viscoelastic testing machine (ARES, manufactured by Rheometrics Inc.), and viscoelasticity is measured in a shear mode at a temperature range of −70° C. to 150° C. at a heating rate of 5° C./min, and a peak top temperature of tan δ is defined as Tg of the homopolymer.

The acrylic polymer according to the present aspect is not particularly limited, and preferably has an SP value of 23.0 (MJ/m³)^{1/2} or less. The SP value is more preferably 21.0 (MJ/m³)^{1/2} or less (for example, 20.0 (MJ/m³)^{1/2} or less).

A lower limit of the SP value is not particularly limited, and is, for example, about 10.0 (MJ/m³)^{1/2} or more, appropriately about 15.0 (MJ/m³)^{1/2} or more, and preferably 18.0 (MJ/m³)^{1/2} or more.

The SP value of the acrylic polymer can be calculated according to a Fedors calculation method [see “Polymer Engineering and Science (POLYMER ENG. & SCI.)”, Vol. 14, No. 2 (1974), pp. 148 to 154], that is, a formula: SP value δ=(ΣΔe/ΣΔv)^{1/2} (in the above formula, Δe is vaporization energy Δe of each atom or atomic group at 25° C., and Δv is a molar volume of each atom or atomic group at the same temperature). The acrylic polymer having the SP value can be obtained by appropriately determining a monomer composition based on technical knowledge of those skilled in the art.

The pressure-sensitive adhesive composition contains the monomer components containing the compositions described above in a form of a polymer, an unpolymerized product (that is, a form in which a polymerizable functional group is unreacted), or a mixture thereof.

The pressure-sensitive adhesive composition may be in various forms such as an aqueous dispersion type pressure-sensitive adhesive composition in which a pressure-sensitive adhesive (pressure-sensitive adhesive component) is dispersed in water, a solvent type pressure-sensitive adhesive composition in which a pressure-sensitive adhesive is contained in an organic solvent, an active energy ray curable pressure-sensitive adhesive composition which is prepared to form a pressure-sensitive adhesive by curing with active energy rays such as ultraviolet rays and radiation, and a hot-melt pressure-sensitive adhesive composition which is coated in a heated and melted state and forms an pressure-sensitive adhesive when cooled to around room temperature. The pressure-sensitive adhesive composition according to a preferred aspect is a solvent type pressure-sensitive adhesive composition.

In the polymerization, a known or commonly used thermal polymerization initiator or photoradical polymerization initiator may be used depending on a polymerization method, a polymerization mode, and the like. These polymerization initiators can be used alone or in combination of two or more kinds thereof.

Although the thermal polymerization initiator is not particularly limited, for example, an azo polymerization initiator, a peroxide initiator, and a redox initiator obtained by combining a peroxide and a reducing agent, a substituted ethane initiator, or the like can be used.

More specific examples include, but are not limited to, azo initiators such as 2,2′-azobisisobutyronitrile (AIBN), 2,2′-azobis(2-methyl propionamidine) disulfate, 2,2′-azobis(2-amidinopropane) dihydrochloride, 2,2′-azobis[2-(5-methyl-2-imidazoline-2-yl) propane] dihydrochloride, 2,2′-azobis(N,N′-dimethylene isobutylamidine), 2,2′-azobis[N-(2-carboxyethyl)-2-methylpropionamidine] hydrate; persulfates such as potassium persulphate and ammonium persulphate; peroxide initiators such as benzoyl peroxide, t-butyl hydroperoxide, and hydrogen peroxide; substituted ethane initiators such as phenyl-substituted ethanes; and redox initiators such as a combination of persulfate and sodium hydrogen sulfite, and a combination of a peroxide and sodium ascorbate. Thermal polymerization may be preferably carried out at a temperature of about 20° C. to 100° C. (typically 40° C. to 80° C.).

Although the photoradical polymerization initiator is not particularly limited, examples thereof include 1-[4-(2-hydroxyethoxy)-phenyl]-2-hydroxy-2-methyl-1-propan-1-one, 1-hydroxy-cyclohexyl-phenyl-ketone, benzophenone, 2,2-dimethoxy-1,2-diphenylethane-1-one, 2,4,6-trimethylbenzoyl-diphenyl-phosphine oxide, 2,4,6-trimethylbenzoyl-phenylethoxy-phosphine oxide, 2-benzyl-2-dimethylamino-1-(4-morpholinophenyl)-butanone-1,2-hydroxy-2-methyl-1-phenyl-propan-1-one, 2-methyl-1-(4-methylthiophenyl)-2-morpholinopropan-1-one, benzoin methyl ether, benzoin ethyl ether, benzoin isobutyl ether, benzoin isopropyl ether, bis(2,4,6-trimethylbenzoyl)-phenylphosphine oxide, 2-hydroxy-2-methyl-[4-(1-methylvinyl)phenyl]propanol oligomer, 2-hydroxy-2-methyl-1-phenyl-1-propanone, isopropylthioxanthone, methyl o-benzoylbenzoate, [4-(methylphenylthio)phenyl]phenylmethane, 2,4-diethylthioxanthone, 2-chlorothioxanthone, ethylanthraquinone, benzophenone ammonium salts, thioxanthone ammonium salts, bis(2,6-dimethylbenzoyl)-2,4,4-trimethyl-pentylphosphine oxide, 2,4,6-trimethylbenzophenone, 4-methylbenzophenone, 4,4′-bisdiethylaminobenzophenone, 1,4-dibenzoylbenzene, 10-butyl-2-chloroacridone, 2,2′-bis(o-chlorophenyl)-4,5,4′,5′-tetrakis(3,4,5-trimethoxyphenyl)-1,2′-biimidazole, 2,2′-bis(o-chlorophenyl)-4,5,4′,5′-tetraphenyl-1,2′-biimidazole, 2-benzoylnaphthalene, 4-benzoylbiphenyl, 4-benzoyldiphenyl ether, acrylated benzophenone, bis(η5-2,4-cyclopentadiene-1-yl)-bis[2,6-difluoro-3-(1H-pyrrol-1-yl)-phenyl]titanium, o-methylbenzoyl benzoate, p-dimethyl aminobenzoic acid ethyl ester, p-dimethyl aminobenzoic acid isoamyl ethyl ester, active tertiary amine, arbazol-phenone photoinitiator, acridine photoinitiator, triazine photoinitiator, and benzoyl photoinitiator. These are used alone or in combination of two or more kinds thereof.

A used amount of the thermal polymerization initiator or the photoradical polymerization initiator may be set to a normal used amount according to a polymerization method, a polymerization mode, and the like, and is not particularly limited. For example, about 0.001 parts by mass to 5 parts by mass (typically about 0.01 parts by mass to 2 parts by mass, for example, about 0.01 parts by mass to 1 part by mass) of the polymerization initiator can be used with respect to 100 parts by mass of the monomer to be polymerized.

For the polymerization, various known chain transfer agents (which can also be understood as molecular weight modifiers or polymerization degree modifiers) in the related art can be used as necessary.

Examples of the chain transfer agents include mercaptans such as n-dodecyl mercaptan, t-dodecyl mercaptan, thioglycolic acid, and a-thioglycerol.

Alternatively, a chain transfer agent containing no sulfur atom (non-sulfur-based chain transfer agent) may be used. Specific examples of the non-sulfur-based chain transfer agent include anilines such as N,N-dimethyl aniline and N,N-diethyl aniline; terpenoids such as a-pinene and terpinolene; styrenes such as α-methylstyrene and α-methyl styrene dimer; compounds having a benzylidenyl group such as dibenzylideneacetone, cinnamyl alcohol and cinnamyl aldehyde; hydroquinones such as hydroquinone and naphthohydroquinone; quinones such as benzoquinone and naphthoquinone; olefins such as 2,3-dimethyl-2-butene and 1,5-cyclooctadiene; alcohols such as phenol, benzyl alcohol, and allyl alcohol; and benzyl hydrogens such as diphenylbenzene and triphenylbenzene.

The chain transfer agents may be used alone or in combination of two or more kinds thereof. When the chain transfer agent is used, a used amount thereof can be, for example, about 0.01 parts by mass to 1 part by mass with respect to 100 parts by mass of the monomer component. The technique according to the present aspect may be preferably carried out in an aspect in which a chain transfer agent is not used.

A molecular weight of the acrylic polymer obtained by appropriately adopting the various polymerization methods described above is not particularly limited, and may be set within an appropriate range according to required performance A weight-average molecular weight (Mw) of the acrylic polymer is usually about 10×10⁴ or more (for example, 20×10⁴ or more), and is preferably more than 30×10⁴ from the viewpoint of achieving good balance between the cohesive force and adhesive force.

The acrylic polymer according to one aspect has Mw of preferably 40×10⁴ or more (typically about 50×10⁴ or more, for example, about 55×10⁴ or more) from the viewpoint of obtaining good adhesion reliability even in a high-temperature environment. According to a preferable aspect of the technique according to the present aspect, since the gelation can be prevented by designing the monomer composition, it is possible to obtain the high-molecular-weight substance within the above range with good productivity by setting an appropriate solid content concentration.

An upper limit of Mw of the acrylic polymer may be usually about 500×10⁴ or less (for example, about 150×10⁴ or less). The Mw may be about 75×10⁴ or less.

Here, Mw means a value in terms of standard polystyrene obtained by a gel permeation chromatography (GPC). As a GPC apparatus, for example, a model name “HLC-8320GPC” (column: TSKgelGMH-H(S), manufactured by Tosoh Corporation) may be used.

The Mw can be Mw of the acrylic polymer either in the pressure-sensitive adhesive composition or in the pressure-sensitive adhesive layer.

The pressure-sensitive adhesive composition according to some aspects may be an active energy ray curable pressure-sensitive adhesive composition. Examples of active energy rays herein include light such as ultraviolet rays, visible rays, and infrared rays, radiation such as α rays, β rays, γ rays, electron beams, neutron rays, and X rays, and energy rays having energy capable of causing a chemical reaction such as a polymerization reaction, a crosslinking reaction, and decomposition of an initiator.

Preferable examples of the active energy ray curable pressure-sensitive adhesive composition include a photocurable pressure-sensitive adhesive composition. The photocurable pressure-sensitive adhesive composition has an advantage that even a thick pressure-sensitive adhesive layer can be easily formed. Among them, an ultraviolet ray curable pressure-sensitive adhesive composition is preferred.

The photocurable pressure-sensitive adhesive composition typically contains at least a part of the monomer components of the composition (may be part of the type of monomer or part of an amount) in the form of a polymer.

The polymerization method for forming the polymer is not particularly limited, and various known polymerization methods in the related art can be appropriately employed. For example, thermal polymerization such as solution polymerization, emulsion polymerization, and bulk polymerization (which is typically performed in the presence of the thermal polymerization initiator); photopolymerization (which is typically performed in the presence of the photoradical polymerization initiator) carried out by irradiation with light such as ultraviolet rays; and radiation polymerization performed by irradiation with radiation rays such as β rays or γ rays can be appropriately employed. Among them, the photopolymerization is preferable.

The photocurable pressure-sensitive adhesive composition according to a preferred aspect contains a partially polymerized product of the monomer components. Such a partially polymerized product is typically a mixture of a polymer derived from the monomer components and an unreacted monomer, preferably a syrup (viscous liquid). Hereinafter, the partially polymerized product having such a property may be sometimes referred to as “monomer syrup” or simply “syrup”.

The polymerization method for partially polymerizing the monomer components is not particularly limited, and various polymerization methods as described above can be appropriately selected and used. From the viewpoints of efficiency and convenience, a photopolymerization method can be preferably adopted. According to photopolymerization, the polymerization conversion (monomer conversion) of the monomer components can be easily controlled by polymerization conditions such as an irradiation amount (light amount) of light.

The polymerization conversion of the monomer mixture in the partially polymerized product is not particularly limited. The polymerization conversion can be, for example, about 70% by weight or less, preferably about 60% by weight or less.

From the viewpoint of ease of preparation and coatability of the pressure-sensitive adhesive composition containing the partially polymerized product, the polymerization conversion is usually suitably about 50% by weight or less, preferably about 40% by weight or less (for example, about 35% by weight or less). A lower limit of the polymerization conversion is not particularly limited, and is typically about 1% by weight or more, and usually suitably about 5% by weight or more.

The pressure-sensitive adhesive composition containing the partially polymerized product of the monomer components can be obtained by, for example, partially polymerizing the monomer mixture containing a total amount of the monomer components used in the preparation of the pressure-sensitive adhesive composition by an appropriate polymerization method (for example, photopolymerization method).

The pressure-sensitive adhesive composition containing the partially polymerized product of the monomer components may be a mixture of a partially or completely polymerized product of the monomer mixture containing a part of the monomer components used in the preparation of the pressure-sensitive adhesive composition and remaining monomer components or partially polymerized product thereof. The term “completely polymerized product” as used herein means that the polymerization conversion is more than 95% by weight.

(Material that is Discolored by Water or Water Vapor)

The pressure-sensitive adhesive composition according to one embodiment of the present invention contains a material that is discolored by water or water vapor (hereinafter, also referred to as a water discolorable material). A type of the water discolorable material is not limited as long as the water discolorable material is discolored by the water or the water vapor.

Here, “discolored” means that a color thereof changes due to the water or the water vapor, and is a concept that includes a loss of the color by the water or the water vapor, appearance of the color by water or water vapor, and a change of an original color to a different color by the water or the water vapor.

The water discolorable material according to the present aspect preferably contains a transition metal compound capable of coordinating with a water molecule. The transition metal compound is discolored when energy of a d orbital of the metal changes due to the coordination of water (hydration reaction) and an absorption spectrum of visible light changes. Since such a hydration reaction is a reversible reaction, the reaction can be reused by drying the water discolorable material after the hydration reaction.

Examples of the transition metal compound capable of coordinating with the water molecule include cobalt chloride, copper sulfate, and copper chloride. A color of cobalt chloride changes from blue to red when cobalt chloride is coordinated with the water molecule, a color of copper sulfate changes from white to blue when copper sulfate is coordinated with the water molecule, and a color of copper chloride changes from yellow to blue when copper chloride is coordinated with the water molecule.

Among them, cobalt chloride is preferable since the cobalt chloride has high compatibility with the base polymer, particularly the acrylic polymer, and can be easily distinguished visually since a change in color spectrum is remarkable.

The water discolorable material according to the present aspect may be used alone or in combination of two or more kinds thereof.

The water discolorable material according to the present aspect is preferably 0.5 parts by mass to 100 parts by mass, more preferably 1 part by mass to 80 parts by mass, still more preferably 3 parts by mass to 70 parts by mass, and yet still more preferably 10 parts by mass to 50 parts by mass, based on 100 parts by mass of the base polymer. Within the above range, discoloration of the water discolorable material can be observed remarkably.

In the pressure-sensitive adhesive composition according to one embodiment of the present invention, in order to uniformly mix the water discolorable material in the composition, the water discolorable material is preferably mixed with the above-mentioned base polymer in a state of being dissolved in a polar solvent. That is, the pressure-sensitive adhesive composition according to one embodiment of the present invention preferably contains the polar solvent. The polar solvent preferably contains at least one of alcohols, ketones, and aromatic compounds containing a nitrogen atom in a molecule thereof.

Examples of the alcohols include ethanol and methanol.

Examples of the ketones include acetone.

Examples of the aromatic compounds containing a nitrogen atom in the molecule thereof include quinoline and benzonitrile.

Among them, from the viewpoint of compatibility with a polymerization solvent that can be contained in the base polymer solution, the polar solvent is preferably the alcohols.

When the pressure-sensitive adhesive composition according to one embodiment of the present invention contains the polar solvent, the polar solvent is preferably 1 ppm by mass or more, more preferably 3 ppm by mass or more, still more preferably 5 ppm by mass or more, and particularly preferably 10 ppm by mass or more relative to the pressure-sensitive adhesive composition.

(Peeling Force Increasing Agent)

The pressure-sensitive adhesive composition according to one embodiment of the present invention may contain a peeling force increasing agent. A material capable of exhibiting a function of increasing the peeling force of the pressure-sensitive adhesive sheet from the adherend after attaching a surface (pressure-sensitive adhesive surface) of the pressure-sensitive adhesive layer formed by the pressure-sensitive adhesive composition to the adherend may be appropriately selected and used as the peeling force increasing agent.

For example, a known silane coupling agent can be used as the peeling force increasing agent. The peeling force increasing agent is preferably contained in the pressure-sensitive adhesive composition (and thus the pressure-sensitive adhesive layer) in a free form. Typically, it is preferred that the peeling force increasing agent does not chemically bond with other components that may be contained in the pressure-sensitive adhesive composition (and thus the pressure-sensitive adhesive layer). The peeling force increasing agent contained in the pressure-sensitive adhesive composition in such a form can effectively contribute to improvement of the peeling force.

The silane coupling agent is typically a compound which contains a functional group X and a functional group Y in one molecule and in which the functional group X is an alkoxysilyl group. The alkoxysilyl group is a functional group having at least one alkoxy group on a silicon atom.

When the silane coupling agent is supplied to the surface of the pressure-sensitive adhesive layer after the pressure-sensitive adhesive sheet is attached to the adherend, a silanol group generated by a hydrolysis of the alkoxy group and a hydroxyl group on a surface of the adherend are reacted with each other, and thus the peeling force of the pressure-sensitive adhesive sheet from the adherend can be increased. The alkoxysilyl group generates the silanol group that reacts with the hydroxyl group of the surface of the adherend by the hydrolysis. Therefore, the alkoxysilyl group is a precursor of a group capable of reacting with the hydroxyl group.

The alkoxy group constituting the alkoxysilyl group is typically a methoxy group or an ethoxy group. Normally, a methoxy group having higher hydrolyzability is preferable. The alkoxysilyl group may be a trialkoxysilyl group or a dialkoxysilyl group. From the viewpoint of enhancing an effect of increasing the peeling force, a silane coupling agent having the trialkoxysilyl group can be preferably used in some aspects.

Examples of the functional group Y may include an epoxy group, an amino group, an isocyanate group (may constitute an isocyanurate), an acetoacetyl group, a (meth)acryloyl group, a mercapto group, a vinyl group, and a halogenated alkyl group.

Examples of the silane coupling agent having such a functional group Y include epoxy group-containing silane coupling agents such as 3-glycidoxypropyltrimethoxysilane and 3-glycidoxypropyltriethoxysilane, 3-glycidoxypropylmethyldimethoxysilane, 2-(3,4-epoxycyclohexyl)ethyltrimethoxysilane; amino group-containing silane coupling agents such as 3-aminopropyltrimethoxysilane, N-(2-aminoethyl)3-aminopropyltrimethoxysilane, N-(2-aminoethyl)3-aminopropylmethyldimethoxysilane; isocyanate group-containing silane coupling agents such as 3-isocyanatepropyltriethoxysilane, tris(trimethoxysilylpropyl)isocyanurate; acetoacetyl group-containing silane coupling agents such as an acetoacetyl group-containing trimethoxysilane; (meth)acryloyl group-containing silane coupling agents such as 3-methacryloxypropyl trimethoxy silane, 3-methacryloxypropyltriethoxysilane, 3-acryloxypropyltrimethoxysilane; vinyl group-containing silane coupling agents such as vinyltrimethoxysilane and vinyltriethoxysilane; mercapto group-containing silane coupling agents such as 3-methacryloxypropylmethyldimethoxysilane and 3-methacryloxypropyltrimethoxysilane; and halogenated alkyl group-containing silane coupling agents such as 3-chloropropyltrimethoxysilane. Among them, epoxy group-containing silane coupling agents such as a glycidoxypropyltrialkoxysilane (for example, 3-glycidoxypropyltrimethoxysilane or 3-glycidoxypropyltriethoxysilane) are preferable.

As the silane coupling agent, one having the functional group Y that reacts with a functional group y contained in the pressure-sensitive adhesive layer can be used. From the viewpoint of reactivity at room temperature, examples thereof include a combination of a carboxy group as the functional group y and a silane coupling agent having an epoxy group as the functional group Y. Examples of other combinations include a combination of an amino group and an epoxy group, a combination of a hydroxyl group and an epoxy group, a combination of a carboxy group and an amino group, a combination of an isocyanate group and an amino group, and a combination of a sulfo group and an amino group.

On the other hand, in some aspects, the pressure-sensitive adhesive composition may not have the functional group y (for example, a carboxy group) that reacts with the functional group Y (for example, an epoxy group) of the silane coupling agent, from the viewpoint of facilitating a shift of the peeling force increasing agent to the surface by maintaining the peeling force increasing agent in a free state in the pressure-sensitive adhesive composition.

A molecular weight (chemical formula weight) of the silane coupling agent is not particularly limited, and may be, for example, about 120 to 1000. In general, a silane coupling agent having a molecular weight of 180 or more and 200 or more, or 220 or more is preferable from the viewpoint of ease of adjustment of a reworkable period and mobility to the pressure-sensitive adhesive surface.

For the same reason, a silane coupling agent having a molecular weight of 800 or less, 600 or less, 400 or less, or 300 or less is preferable. In some aspects, a silane coupling agent having a molecular weight of 200 or more and 300 or less can be preferably used.

As a value of the molecular weight of the silane coupling agent, a value calculated based on a structural formula of the silane coupling agent is used. Alternatively, a manufacturer nominal value may be used.

An amount of the peeling force increasing agent (for example, silane coupling agent) contained in the pressure-sensitive adhesive composition according to one embodiment of the present invention can be set so as to obtain a desired use effect, and is not particularly limited.

The amount of the peeling force increasing agent can be, for example, 0.005 parts by mass or more per 100 parts by mass of the base polymer contained in the pressure-sensitive adhesive composition. A content of the peeling force increasing agent per 100 parts by mass of the base polymer is usually suitably 0.05 parts by mass or more, and may be 0.10 parts by mass or more, 0.20 parts by mass or more, or 0.30 parts by mass or more. As the content of the peeling force increasing agent increases, it is possible to exhibit the effect of increasing the peeling force.

Depending on a use mode, if a period until the peeling force increases over time at room temperature is too short, the reworkable period becomes too short, which may cause a problem such as complicating process control. From such a viewpoint, in some aspects, the content of the peeling force increasing agent per 100 parts by mass of the base polymer in the pressure-sensitive adhesive composition may be, for example, 5 parts by mass or less, 3 parts by mass or less, 1 part by mass or less, 0.7 parts by mass or less (for example, 0.5 parts by mass or less).

(Crosslinking Agent)

The pressure-sensitive adhesive composition according to one embodiment of the present invention can optionally contain a crosslinking agent mainly for the purpose of crosslinking within the pressure-sensitive adhesive layer or crosslinking between the pressure-sensitive adhesive layer and an adjacent surface thereof.

A type of the crosslinking agent is not particularly limited and can be selected from known crosslinking agents in the related art so that the crosslinking agent exhibits an appropriate crosslinking function in the pressure-sensitive adhesive layer according to the composition of the pressure-sensitive adhesive composition, for example.

Examples of the crosslinking agent that may be used include an isocyanate-based crosslinking agent, an epoxy-based crosslinking agent, an oxazoline-based crosslinking agent, an aziridine-based crosslinking agent, a carbodiimide-based crosslinking agent, a melamine-based crosslinking agent, a urea-based crosslinking agent, a metal alkoxide-based crosslinking agent, a metal chelate-based crosslinking agent, a metal salt-based crosslinking agent, a hydrazine-based crosslinking agent, and an amine-based crosslinking agent. These can be used alone or in combination of two or more kinds thereof.

As the isocyanate-based crosslinking agent, a polyfunctional isocyanate compound having a functionality of 2 or more can be used. Examples thereof include aromatic isocyanates such as tolylene diisocyanate, xylylene diisocyanate, polymethylene polyphenyl diisocyanate, tris(p-isocyanatophenyl)thiophosphate, and diphenylmethane diisocyanate; alicyclic isocyanates such as isophorone diisocyanate; and aliphatic isocyanates such as hexamethylene diisocyanate.

Examples of commercially available products include isocyanate adducts such as ethyl acetate which is a m-xylylene diisocyanate trimethylolpropane adduct (trade name “Takenate D110N”, manufactured by Mitsui Chemicals, Inc.), a trimethylolpropane/tolylene diisocyanate trimer adduct (manufactured by Tosoh Corporation, trade name “CORONATE L”), trimethylolpropane/hexamethylene diisocyanate trimer adduct (manufactured by Tosoh Corporation, trade name “CORONATE HL”), and an isocyanurate of hexamethylene diisocyanate (manufactured by Tosoh Corporation, trade name “CORONATE HX”).

As the epoxy-based crosslinking agent, those having two or more epoxy groups in one molecule can be used without particular limitation. An epoxy-based crosslinking agent having 3 to 5 epoxy groups per molecule is preferable.

Specific examples of the epoxy-based crosslinking agents include N,N,N′,N′-tetraglycidyl-m-xylenediamine, 1,3-bis(N,N-diglycidylaminomethyl)cyclohexane, 1,6-hexanediol diglycidyl ether, polyethylene glycol diglycidyl ether, and polyglycerol polyglycidyl ether.

Examples of commercially available epoxy-based crosslinking agents include “TETRAD-X” and “TETRAD-C” (trade name) manufactured by Mitsubishi Gas Chemical Company, Inc., “Epiclon CR-5L” (trade name) manufactured by DIC Corporation, “Denacol EX-512” (trade name) manufactured by Nagase Chemtex Corporation, and “TEPIC-G” (trade name) manufactured by Nissan Chemical Corporation.

As the oxazoline-based crosslinking agent, those having one or more oxazoline groups in one molecule can be used without particular limitation.

Examples of the aziridine-based crosslinking agent include trimethylolpropane tris[3-(1-aziridinyl)propionate] and trimethylolpropane tris[3-(1-(2-methyl)aziridinyl propionate)].

A low-molecular-weight compound or a high-molecular-weight compound having two or more carbodiimide groups can be used as the carbodiimide-based crosslinking agent.

In some aspects, a peroxide may be used as a crosslinking agent. Examples of the peroxide include di(2-ethylhexyl)peroxydicarbonate, di(4-t-butylcyclohexyl)peroxydicarbonate, di-sec-butyl peroxydicarbonate, t-butyl peroxyneodecanoate, t-hexyl peroxypivalate, t-butyl peroxypivalate, dilauroyl peroxide, Di-n-octanoyl peroxide, 1,1,3,3-tetramethylbutyl peroxyisobutyrate, and dibenzoyl peroxide.

Among these, di(4-t-butylcyclohexyl)peroxydicarbonate, dilauroyl peroxide, and dibenzoyl peroxide are mentioned as peroxides having particularly excellent crosslinking reaction efficiency.

When the peroxide is used as the polymerization initiator, it is also possible to use a remaining peroxide that has not been used in a polymerization reaction for the crosslinking reaction. In that case, a residual amount of the peroxide is quantified, and if a ratio of the peroxide is less than a predetermined amount, the peroxide may be added as necessary such that the predetermined amount is obtained. The quantification of the peroxide can be performed by a method described in JP4971517B.

A content of the crosslinking agent (total amount of the crosslinking agents when two or more crosslinking agents are contained) is not particularly limited. From the viewpoint of realizing the pressure-sensitive adhesive that exhibits the adhesive properties such as adhesive force and cohesive force in a well-balanced manner, the content of the crosslinking agent is usually appropriately about 5 parts by mass or less, preferably about 0.001 parts by mass to 5 parts by mass, more preferably about 0.001 parts by mass to 4 parts by mass, and still more preferably about 0.001 parts by mass to 3 parts by mass, based on 100 parts by mass of the base polymer contained in the pressure-sensitive adhesive composition. Alternatively, a pressure-sensitive adhesive composition containing no crosslinking agent as described above may be used.

When the photocurable pressure-sensitive adhesive composition is used as the pressure-sensitive adhesive composition according to one embodiment of the present invention, the pressure-sensitive adhesive composition may be substantially free of the crosslinking agents such as an isocyanate-based crosslinking agent. Here, the phrase “the pressure-sensitive adhesive composition is substantially free of the crosslinking agents (typically, the isocyanate-based crosslinking agent)” means that an amount of the crosslinking agent is less than 0.05 parts by mass (for example, less than 0.01 parts by mass) with respect to 100 parts by mass of the base polymer.

In order to more effectively promote the crosslinking reaction, a crosslinking catalyst may be used. Examples of the crosslinking catalyst include metal-based crosslinking catalysts such as tetra-n-butyl titanate, tetraisopropyl titanate, nasem ferric, butyltin oxide, and dioctyltin dilaurate. Among them, a tin-based crosslinking catalyst such as dioctyltin dilaurate is preferable.

A used amount of the crosslinking catalyst is not particularly limited. A used amount of the crosslinking catalyst may be, for example, about 0.0001 parts by mass or more and 1 part by mass or less, may be 0.001 parts by mass or more and 0.1 parts by mass or less, or may be 0.005 parts by mass or more and 0.5 parts by mass or less with respect to 100 parts by mass of the base polymer in the pressure-sensitive adhesive composition.

A polyfunctional monomer may be used as necessary for the pressure-sensitive adhesive composition (and thus pressure-sensitive adhesive layer). The polyfunctional monomer can be useful for purposes such as adjusting cohesive force when used in place of the above-described crosslinking agent or in combination with the crosslinking agent. For example, the polyfunctional monomer may be preferably used in a pressure-sensitive adhesive layer formed from the photocurable pressure-sensitive adhesive composition.

Examples of the polyfunctional monomer include ethylene glycol di(meth)acrylate, propylene glycol di(meth)acrylate, polyethylene glycol di(meth)acrylate, polypropylene glycol di(meth)acrylate, neopentyl glycol di(meth)acrylate, pentaerythritol di(meth)acrylate, pentaerythritol tri(meth)acrylate, dipentaerythritol hexa(meth)acrylate, ethylene glycol di(meth)acrylate, 1,6-hexanediol di(meth)acrylate, 1,12-dodecanediol di(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, urethane acrylate, butyl diol (meth)acrylate, and hexyl diol di(meth)acrylate. Among them, trimethylolpropane tri(meth)acrylate, 1,6-hexanediol di(meth)acrylate, and dipentaerythritol hexa(meth)acrylate can be preferably used. The polyfunctional monomer can be used alone or in combination of two or more kinds thereof.

A used amount of the polyfunctional monomer varies depending on a molecular weight, the number of functional groups thereof, and the like, but is usually appropriately in a range of about 0.01 parts by mass to 3.0 parts by mass with respect to 100 parts by mass of the base polymer. In some aspects, the used amount of the polyfunctional monomer may be, for example, 0.02 parts by mass or more, 0.1 parts by mass or more, 0.5 parts by mass or more, 1.0 part by mass or more, or 2.0 parts by mass or more with respect to 100 parts by mass of the base polymer.

Higher cohesive force tends to be obtained by increasing the used amount of polyfunctional monomer. On the other hand, from the viewpoint of avoiding a decrease in adhesiveness between the pressure-sensitive adhesive layer and the adjacent layer due to excessive cohesive force improvement, the used amount of the polyfunctional monomer may be, for example, 10 parts by mass or less, 5.0 parts by mass or less, or 3.0 parts by mass or less with respect to 100 parts by mass of the base polymer.

(Acrylic Oligomer)

The pressure-sensitive adhesive composition (and thus the pressure-sensitive adhesive layer) according to one embodiment of the present invention can contain an acrylic oligomer from the viewpoint of improving the cohesive force and improving the adhesiveness with the surface (which can be, for example, a surface of a substrate and the like) adjacent to the pressure-sensitive adhesive layer.

As the acrylic oligomer, it is preferable to use a polymer having Tg higher than Tg of the acrylic polymer.

Tg of the acrylic oligomer is not particularly limited, and may be, for example, about 20° C. or higher and 300° C. or lower. The Tg may be, for example, about 30° C. or higher, about 40° C. or higher, about 60° C. or higher, about 80° C. or higher, or about 100° C. or higher.

As Tg of the acrylic oligomer increases, an effect of improving the cohesive force tends to generally increase. Further, from the viewpoint of anchorability to the substrate and impact absorption properties, Tg of the acrylic oligomer may be, for example, about 250° C. or less, about 200° C. or less, about 180° C. or less, or about 150° C. or less. Tg of the acrylic oligomer is a value calculated based on the Fox equation, like Tg of the acrylic polymer corresponding to the composition of the monomer component.

Mw of the acrylic oligomer is typically about 1,000 or more and less than about 30,000, preferably about 1,500 or more and less than about 10,000, and more preferably about 2,000 or more and less than about 5,000. When Mw is within the above range, an effect of improving the cohesiveness and the adhesiveness with the adjacent surface is easily exhibited.

Mw of the acrylic oligomer can be measured by the gel permeation chromatography (GPC) and calculated as a value in terms of standard polystyrene. Specifically, Mw is measured using HPLC8020 manufactured by Tosoh Corporation, using two TSKgelGMH-H(20) columns, and using tetrahydrofuran as a solvent at a flow rate of about 0.5 mL/min.

Examples of the monomer components constituting the acrylic oligomer include (meth)acrylate monomers such as various C₁₋₂₀ (meth)acrylic acid alkyl esters described above; various alicyclic hydrocarbon group-containing (meth)acrylates described above; various aromatic hydrocarbon group-containing (meth)acrylates described above; and (meth)acrylates obtained from terpenic compound derivative alcohols. These can be used alone or in combination of 2 or more kinds thereof.

From the viewpoint of improving the adhesiveness, the acrylic oligomer preferably contains, as a monomer unit, an acrylic monomer having a relatively bulky structure typified by alkyl (meth)acrylates in which an alkyl group has a branched structure, such as isobutyl (meth)acrylate and t-butyl (meth)acrylate; and alicyclic hydrocarbon group-containing (meth)acrylates and aromatic hydrocarbon group-containing (meth)acrylates.

When ultraviolet rays are used in a synthesis of the acrylic oligomer or in the preparation of the pressure-sensitive adhesive layer, a monomer having a saturated hydrocarbon group at an ester terminal is preferable in that it is less likely to cause polymerization inhibition, and for example, alkyl (meth)acrylates in which the alkyl group has the branched structure and saturated alicyclic hydrocarbon group-containing (meth)acrylates can be preferably used.

A proportion of the (meth)acrylate monomer in all monomer components constituting the acrylic oligomer is typically more than 50% by weight, preferably 60% by weight or more, and more preferably 70% by weight or more (for example, 80% by weight or more, and still more preferably 90% by weight or more).

In a preferred aspect, the acrylic oligomer has a monomer composition consisting of substantially only one or more (meth)acrylate monomers. When the monomer components contain the alicyclic hydrocarbon group-containing (meth)acrylate and a C₁₋₂₀ (meth)acrylic acid alkyl ester, a weight ratio thereof is not particularly limited, and can be, for example, a range of 10/90 to 90/10, a range of 20/80 to 80/20, a range of 70/30 to 30/70, and the like.

In addition to the above (meth)acrylate monomers, a functional group-containing monomer can be used as the constituent monomer components of the acrylic oligomer, if necessary.

Examples of the functional group-containing monomer include monomers having a nitrogen atom-containing heterocycle such as N-vinyl-2-pyrrolidone and N-acryloylmorpholine, amino group-containing monomers such as N,N-dimethylaminoethyl (meth)acrylate; amide group-containing monomers such as N,N-diethyl(meth)acrylamide; carboxy group-containing monomers such as AA and MAA; and hydroxyl group-containing monomers such as 2-hydroxyethyl(meth)acrylate.

These functional group-containing monomers may be used alone or in combination of two or more kinds thereof. When the functional group-containing monomer is used, a proportion of the functional group-containing monomer in all the monomer components constituting the acrylic oligomer can be, for example, 1% by weight or more, 2% by weight or more, or 3% by weight or more, and for example, 15% by weight or less, 10% by weight or less, or 7% by weight or less.

Preferable examples of the acrylic oligomer include, for example, copolymers of DCPMA and MMA, copolymers of DCPMA and IBXMA, copolymers of ADA and methyl methacrylate (MMA), copolymers of CHMA and isobutyl methacrylate (IBMA), copolymers of CHMA and IBXMA, copolymers of CHMA and acryloylmorpholine (ACMO), copolymers of CHMA and diethylacrylamide (DEAA), and copolymers of CHMA and AA, in addition to homopolymers such as dicyclopentanyl methacrylate (DCPMA), cyclohexyl methacrylate (CHMA), isobornyl methacrylate (IBXMA), isobornyl acrylate (IBXA), dicyclopentanyl acrylate (DCPA), 1-adamantyl methacrylate (ADMA), and 1-adamantyl acrylate (ADA).

The acrylic oligomer may be formed by polymerizing the constituent monomer components thereof. A polymerization method and a polymerization mode are not particularly limited, and known various polymerization methods (for example, solution polymerization, emulsion polymerization, bulk polymerization, photopolymerization, and radiation polymerization) in the related art can be employed in an appropriate mode. Types of polymerization initiators (for example, an azo polymerization initiator) that may be used as necessary are generally as shown for a synthesis of the acrylic polymer, and an amount of the polymerization initiator and an amount of optionally used chain transfer agent (for example, mercaptans) are appropriately set based on common general technical knowledge so as to achieve a desired molecular weight, and thus a detailed description thereof will be omitted.

When the pressure-sensitive adhesive composition contains the acrylic oligomer, a content thereof can be, for example, 0.01 parts by mass or more, and may be 0.05 parts by mass or more, 0.1 parts by mass or more, or 0.2 parts by mass or more with respect to 100 parts by mass of the base polymer from the viewpoint of obtaining a higher effect.

From the viewpoint of compatibility with the base polymer and the like, the content of the acrylic oligomer is usually suitably less than 50 parts by mass, preferably less than 30 parts by mass, more preferably 25 parts by mass or less, and may be 10 parts by mass or less, 5 parts by mass or less, or 1 part by mass or less.

(Other Components)

As long as effects of the present invention are not impaired, the pressure-sensitive adhesive composition according to one embodiment of the present invention may optionally contain various additives commonly used in the field of pressure-sensitive adhesive compositions, such as tackifying resins (for example, rosin-based, petroleum-based, terpene-based, phenol-based, and ketone-based tackifying resins), viscosity modifiers (for example, thickener), leveling agents, plasticizers, fillers, colorants such as pigments and dyes, stabilizers, preservatives, anti-aging agents, as other optional components. As for such various additives, known ones in the related art can be used in a usual method, and since the additives do not particularly characterize the present invention, a detailed description thereof will be omitted.

The technique according to the present aspect can exhibit good adhesive force without using the above-described tackifying resins, and thus a content of the tackifying resin in the pressure-sensitive adhesive composition can be, for example, less than 10 parts by mass, and further less than 5 parts by mass with respect to 100 parts by mass of the base polymer. The content of the tackifying resin may be less than 1 part by mass (for example, less than 0.5 parts by mass), or less than 0.1 parts by mass (0 parts by mass or more and less than 0.1 parts by mass), and the pressure-sensitive adhesive composition may not contain the tackifying resin.

From the viewpoint of improving transparency, the pressure-sensitive adhesive composition according to one embodiment of the present invention preferably has a limited amount of components other than the base polymer in the pressure-sensitive adhesive composition. In the technique according to the present aspect, an amount of components other than the base polymer in the pressure-sensitive adhesive composition is usually about 30% by weight or less, suitably about 15% by weight or less, preferably about 12% by weight or less (for example, about 10% by weight or less).

An amount of the components other than the base polymer in the pressure-sensitive adhesive composition according to one aspect may be about 5% by weight or less, about 3% by weight or less, or about 1.5% by weight or less (for example, about 1% by weight or less).

Such a composition in which the amount of components other than the base polymer is limited may be preferably adopted for the pressure-sensitive adhesive composition according to the present aspect.

<Method for Producing Pressure-Sensitive Adhesive Composition>

A method for producing a pressure-sensitive adhesive composition according to one embodiment of the present invention includes a step of dissolving a material that is discolored by water or water vapor in a polar solvent, and a step of adding, to a base polymer solution, the material that is discolored by the water of the water vapor which is dissolved in the polar solvent.

First, the material that is discolored by the water or the water vapor is difficult to dissolve in the base polymer as it is, and is dissolved in the polar solvent as a first step. Examples of the polar solvent include those described above.

Next, the water discolorable material dissolved in the polar solvent is added to the base polymer solution and the two are mixed. As the base polymer solution, for example, a base polymer solution prepared by solution polymerization can be used. The base polymer solution preferably contains a polar solvent as the polymerization solvent, and more preferably contains a non-hydrocarbon-based organic solvent such as ethyl acetate. Here, the non-hydrocarbon-based organic solvent means an organic solvent that is not a hydrocarbon-based organic solvent. Since the polar solvent, particularly the non-hydrocarbon-based organic solvent, has high compatibility with the polar solvent in which the water discolorable material is dissolved, the water discolorable material can be uniformly mixed in the obtained pressure-sensitive adhesive composition.

Among them, as the polar solvent that causes the water discolorable material to dissolve, the alcohols, the ketones, or the aromatic compounds containing a nitrogen atom in a molecule thereof are highly compatible with the polar solvent, particularly the non-hydrocarbon-based organic solvent such as ethyl acetate. Therefore, it is more preferable to use the alcohols, the ketones, or the aromatic compounds containing a nitrogen atom in a molecule thereof as the polar solvent that causes the water discolorable material to dissolve, and it is more preferable to use the alcohols.

<Pressure-Sensitive Adhesive Layer>

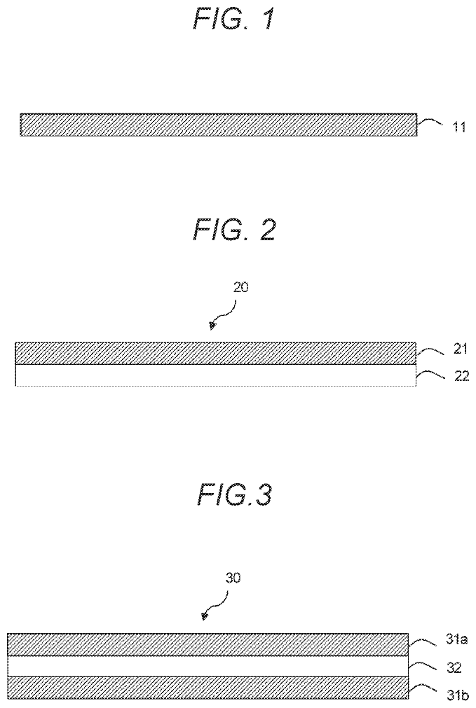

The pressure-sensitive adhesive layer according to one embodiment of the present invention is formed from the pressure-sensitive adhesive composition. FIG. 1 is a schematic cross-sectional view of a configuration example of a pressure-sensitive adhesive layer according to one embodiment of the present invention.

The pressure-sensitive adhesive layer may be a cured layer of the pressure-sensitive adhesive composition. That is, the pressure-sensitive adhesive layer can be formed by applying (for example, coating) the pressure-sensitive adhesive composition to an appropriate surface and then appropriately performing a curing treatment. When two or more kinds of curing treatments (drying, crosslinking, polymerization, and the like) are performed, these can be performed simultaneously or in a plurality of stages.

In the pressure-sensitive adhesive composition using the partially polymerized product (polymer syrup) of the monomer components, a final copolymerization reaction is typically carried out in the curing treatment. That is, the partially polymerized product is subjected to a further copolymerization reaction to form the completely polymerized product.

For example, in the case of a photocurable pressure-sensitive adhesive composition, light irradiation is performed. If necessary, the curing treatment such as crosslinking or drying may be performed. When it is necessary to dry the photocurable pressure-sensitive adhesive composition (for example, in the case of a photocurable pressure-sensitive adhesive composition in which the partially polymerized product of the monomer components is dissolved in an organic solvent), photocuring may be performed after the composition is dried.

The pressure-sensitive adhesive composition using the completely polymerized product is typically subjected to a treatment such as drying (heat drying), crosslinking as necessary as the curing treatment. In the case of the solvent type pressure-sensitive adhesive composition to which photocurability (photocrosslinkability) is imparted by the addition of the polyfunctional monomer, photocuring may be performed after the composition is dried. Here, “after the composition is dried” may be after bonding, to the adherend, the below-described pressure-sensitive adhesive sheet obtained through the drying. The pressure-sensitive adhesive sheet to be described later may be used in an aspect in which the pressure-sensitive adhesive sheet is attached to the adherend by a method including photocuring the pressure-sensitive adhesive sheet after being attached to the adherend.

A pressure-sensitive adhesive layer having a multilayer structure of two or more layers can be produced by laminating pressure-sensitive adhesive layers formed in advance. Alternatively, the pressure-sensitive adhesive composition may be applied onto a first pressure-sensitive adhesive layer formed in advance, and the pressure-sensitive adhesive composition may be cured to form a second pressure-sensitive adhesive layer. When the pressure-sensitive adhesive layer of the pressure-sensitive adhesive sheet, which will be described later, used in an attaching form in which the pressure-sensitive adhesive sheet is photocured after being bonded to the adherend has a multilayer structure, the pressure-sensitive adhesive layer to be photocured may be a part of layers (for example, one layer) in the multilayer structure, or may be all of the layers.

The pressure-sensitive adhesive composition can be applied using a commonly used coater such as a gravure roll coater, a reverse roll coater, a kiss roll coater, a dip roll coater, a bar coater, a knife coater, or a spray coater. In the pressure-sensitive adhesive sheet having a substrate to be described later, a direct method of forming the pressure-sensitive adhesive layer by directly applying the pressure-sensitive adhesive composition to the substrate, or a transfer method of transferring the pressure-sensitive adhesive layer formed on a release surface to the substrate may be used as a method of providing the pressure-sensitive adhesive layer on the substrate.

A thickness of the pressure-sensitive adhesive layer is not particularly limited, and may be, for example, about 3 μm to 2000 μm. In some aspects, the thickness of the pressure-sensitive adhesive layer may be, for example, 5 μm or more, appropriately 10 μm or more, preferably 15 μm or more, and more preferably 25 μm or more from the viewpoint of adhesion to the adherend such as followability to steps. The thickness of the pressure-sensitive adhesive layer may be 50 μm or more, more than 50 μm, 70 μm or more, 100 μm or more, or 120 μm or more.

In some aspects, the thickness of the pressure-sensitive adhesive layer is preferably 5 μm or more, more preferably 10 μm or more, still more preferably 20 μm or more, and particularly preferably 50 μm or more from the viewpoint of making the change in appearance significant when the pressure-sensitive adhesive layer is discolored. Further, the thickness may be 70 μm or more, 100 μm or more, or 120 μm or more.

In some aspects, the thickness of the pressure-sensitive adhesive layer may be, for example, 1000 μm or less, 700 μm or less, 500 μm or less, 300 μm or less, 200 μm or less, or 170 μm or less from the viewpoint of preventing generation of adhesive residue due to cohesive failure of the pressure-sensitive adhesive layer.

The technique according to the present aspect can be appropriately implemented in the form of a pressure-sensitive adhesive sheet to be described later in which a thickness of a pressure-sensitive adhesive layer is 130 μm or less, 90 μm or less, or 60 μm or less (for example, 40 μm or less).

In the pressure-sensitive adhesive sheet to be described later including the pressure-sensitive adhesive layer having a multilayer structure of two or more layers, the thickness of the pressure-sensitive adhesive layer refers to a thickness from a pressure-sensitive adhesive surface attached to the adherend to a surface opposite to the pressure-sensitive adhesive surface.

<Pressure-Sensitive Adhesive Sheet>

The pressure-sensitive adhesive sheet according to one embodiment of the present invention includes the pressure-sensitive adhesive layer. Since the pressure-sensitive adhesive sheet according to the present embodiment has a sheet shape and can be applied to a location where water leakage is assumed, the pressure-sensitive adhesive sheet has good workability as compared with a paste, an adhesive, or the like.

The pressure-sensitive adhesive sheet according to the present embodiment may be a substrate-supported pressure-sensitive adhesive sheet including the pressure-sensitive adhesive layer on one surface or both surfaces of a sheet-shaped substrate (support), or may be a substrate-less pressure-sensitive adhesive sheet including the pressure-sensitive adhesive layer held on a release sheet. The concept of the pressure-sensitive adhesive sheet referred to herein may include those referred to as a pressure-sensitive adhesive tape, a pressure-sensitive adhesive label, a pressure-sensitive adhesive film, and the like.

The pressure-sensitive adhesive layer is typically formed continuously, but is not limited to such a form, and may be, for example, a pressure-sensitive adhesive layer formed in a regular or random pattern such as a dot pattern or a stripe pattern. Further, the pressure-sensitive adhesive sheet according to the present embodiment may have a roll shape or a sheet shape. Alternatively, the pressure-sensitive adhesive sheet may be processed into various shapes.

(Substrate)

The pressure-sensitive adhesive sheet according to some aspects may be a pressure-sensitive adhesive sheet in which the pressure-sensitive adhesive layer is provided on the substrate. That is, the pressure-sensitive adhesive sheet may be in the form of a substrate-supported pressure-sensitive adhesive sheet including a substrate bonded to the other back surface of the pressure-sensitive adhesive layer.

FIG. 2 is a schematic cross-sectional view of a configuration example in which a pressure-sensitive adhesive layer is formed on one side of a substrate in a pressure-sensitive adhesive sheet according to one embodiment of the present invention. The pressure-sensitive adhesive sheet 20 shown in FIG. 2 includes a substrate 22 and a pressure-sensitive adhesive layer 21 formed on one side of the substrate 22.

As another aspect, FIG. 3 shows a schematic cross-sectional view of a configuration example in which pressure-sensitive adhesive layers are formed on both sides of a substrate. The pressure-sensitive adhesive sheet 30 shown in FIG. 3 includes a substrate 32, and a first pressure-sensitive adhesive layer 31a and a second pressure-sensitive adhesive layer 31b formed on both surfaces of the substrate 32.

A material of the substrate is not particularly limited, and can be appropriately selected according to a use mode of the pressure-sensitive adhesive sheet. Non-limiting examples of the substrate that may be used include: plastic films, for example, polyolefin films containing polyolefins such as polypropylene and an ethylene-propylene copolymer as main components, polyester films containing polyester such as polyethylene terephthalate and polybutylene terephthalate as main components, and polyvinyl chloride films containing polyvinyl chloride as main components; foam sheet made of foam such as polyurethane foam, polyethylene foam, polychloroprene foam; woven fabrics and non-woven fabrics made of various fibrous materials (natural fibers such as hemp and cotton, synthetic fibers such as polyester and vinylon, semi-synthetic fibers such as acetate) alone or by blending the various fibrous materials; papers such as a Japanese paper, a pure paper, a kraft paper, a crepe paper; and metal foils such as an aluminum foil and a copper foil. A substrate having a structure in which these are combined may be used.

Examples of the substrate having such a composite structure include a substrate having a structure in which a metal foil and a plastic film are laminated, and a plastic sheet reinforced with inorganic fibers such as a glass cloth.

The substrate used for the pressure-sensitive adhesive sheet according to one embodiment of the present invention is preferably a substrate that is not discolored due to the water or the water vapor. Since the substrate is a substrate that is not discolored by the water or the water vapor, when the pressure-sensitive adhesive sheet is attached to an assumed water leakage location, there is no risk of discoloration of the substrate due to the water or the water vapor generated from areas other than the assumed water leakage location, and thus it is possible to accurately detect leakage of the water or the water vapor from the assumed water leakage location.

Further, the substrate is preferably made of a material having high transparency, from the viewpoint of making the change in appearance significant when the pressure-sensitive adhesive layer is discolored.

Various films (hereinafter also referred to as support films) can be preferably used as the substrate of the pressure-sensitive adhesive sheet according to one embodiment of the present invention. The support film may be a porous film such as a foam film or a non-woven fabric sheet, a non-porous film, or a film having a structure in which a porous layer and a non-porous layer are laminated.

In some aspects, as the support film, a film containing a resin film capable of independently maintaining a shape thereof (which is self-standing or independent) as a base film can be preferably used.

Here, the term “resin film” refers to a resin film that has a non-porous structure and is typically substantially free of air bubbles (voidless). Therefore, the resin film is conceptually distinguished from the foam film and the non-woven fabric. The resin film may have a single-layer structure or a multilayer structure of two or more layers (for example, a three-layer structure).

As a resin material constituting the resin film, for example, a resin such as polyester, polyolefin, polycycloolefin derived from monomers having an alicyclic structure such as a norbornene structure, nylon 6, nylon 66, polyamide (PA) such as partially aromatic polyamide, polyimide (PI), polyamideimide (PAI), polyetheretherketone (PEEK), polyethersulfone (PES), polyphenylene sulfide (PPS), polycarbonate (PC), polyurethane (PU), an ethylene-vinyl acetate copolymer (EVA), polystyrene, polyvinyl chloride, polyvinylidene chloride, fluorine resins such as polytetrafluoroethylene (PTFE), acrylic resins such as polymethyl methacrylate, cellulose-based polymers such as diacetyl cellulose and triacetylcellulose, vinyl butyral-based polymers, arylate-based polymers, polyoxymethylene-based polymers, and epoxy-based polymers.

The resin film may be formed using a resin material containing one of these resins alone, or may be formed using a resin material in which two or more types of materials are blended. The resin film may be nonoriented or oriented (for example, uniaxially oriented or biaxially oriented).

Preferable examples of the resin material constituting the resin film include a polyester-based resin, a PPS resin, and a polyolefin-based resin.

Here, the term “polyester-based resin” refers to a resin containing polyester in a proportion of more than 50% by weight.

Similarly, the PPS resin refers to a resin containing PPS in a proportion exceeding 50% by weight, and the polyolefin-based resin refers to a resin that contains polyolefins in a proportion exceeding 50% by weight.

As the polyester-based resin, a polyester-based resin containing a polyester obtained by polycondensation of dicarboxylic acid and diol as a main component is typically used. Specific examples of the polyester-based resin include polyethylene terephthalate (PET), polybutylene terephthalate (PBT), polyethylene naphthalate (PEN), and polybutylene naphthalate.

As the polyolefin-based resin, one kind of polyolefin may be used alone, or two or more kinds of polyolefins may be used in combination. The polyolefin may be, for example, an α-olefin homopolymer, a copolymer of two or more α-olefins, or a copolymer of one or more α-olefins and other vinyl monomers.

Specific examples thereof include polyethylene, polypropylene (PP), poly-1-butene, poly-4-methyl-1-pentene, ethylene-propylene copolymers such as ethylene-propylene rubber (EPR), an ethylene-propylene-butene copolymer, an ethylene-butene copolymer, an ethylene-vinyl alcohol copolymer, and an ethylene-ethyl acrylate copolymer.

Both low-density (LD) and high-density (HD) polyolefins can be used. Examples of a polyolefin-based resin film include a nonoriented polypropylene (CPP) film, a biaxially oriented polypropylene (OPP) film, a low-density polyethylene (LDPE) film, a linear low-density polyethylene (LLDPE) film, a medium-density polyethylene (MDPE) film, a high-density polyethylene (HDPE) film, a polyethylene (PE) film in which two or more kinds of polyethylene (PE) are blended, and a PP/PE blend film in which polypropylene (PP) and polyethylene (PE) are blended.

Specific examples of the resin film preferably used as a substrate include a PET film, a PEN film, a PPS film, a PEEK film, a CPP film, and an OPP film.

A PET film, a PEN film, a PPS film and a PEEK film are preferred from the viewpoint of strength. A preferred example is the PET film from the viewpoint of availability, dimensional stability, optical properties, and the like.

A known additive such as a light stabilizer, an antioxidant, an antistatic agent, a colorant (such as dyes or pigments), a filler, a slip agent, and an antiblocking agent may be added to the resin film if necessary. A blending quantity of the additive is not particularly limited, and can be appropriately set depending on a use of the pressure-sensitive adhesive sheet.

A method for producing the resin film is not particularly limited. For example, known general resin film forming methods in the related art such as extrusion molding, inflation molding, T-die casting, calendar roll molding, and the like can be used as appropriate.

The substrate may be substantially formed from such a resin film. Alternatively, the substrate may include an auxiliary layer in addition to the resin film. Examples of the auxiliary layer include an optical property adjusting layer (for example, an antireflection layer), a printed layer or laminate layer that imparts a desired appearance to the substrate or the pressure-sensitive adhesive sheet, an antistatic layer, an undercoat layer, a surface treatment layer such as a release layer. Further, the substrate may be an optical member to be described later.

A thickness of the substrate is not particularly limited, and may be selected according to an intended use, a use mode, and the like of the pressure-sensitive adhesive sheet. The thickness of the substrate may be, for example, 1000 μm or less, 500 μm or less, 100 μm or less, 70 μm or less, 50 μm or less, 25 μm or less, 10 μm or less, or 5 μm or less.

When the thickness of the substrate is reduced, flexibility of the pressure-sensitive adhesive sheet and followability to a surface shape of the adherend tend to be improved. From the viewpoint of handleability, workability, and the like, the thickness of the substrate may be, for example, 2 μm or more, and may be 5 μm or more or 10 μm or more. In some aspects, the thickness of the substrate may be, for example, 20 μm or more, 35 μm or more, or 55 μm or more.

A surface of the substrate to be bonded to the pressure-sensitive adhesive layer may be subjected, if necessary, to a known surface treatment in the related art such as a corona discharge treatment, a plasma treatment, an ultraviolet irradiation treatment, an acid treatment, an alkali treatment, an application of an undercoat (primer), and an antistatic treatment. Such a surface treatment may be a treatment for improving adhesion between the substrate and the pressure-sensitive adhesive layer, in other words, anchorability of the pressure-sensitive adhesive layer to the substrate.

The composition of the primer is not particularly limited, and can be appropriately selected from known ones.

A thickness of an undercoat layer is not particularly limited, but is usually appropriately about 0.01 μm to 1 μm, preferably about 0.1 μm to 1 μm.

A surface (hereinafter also referred to as a back surface) of the substrate opposite to the side to be bonded to the pressure-sensitive adhesive layer may be subjected to a known surface treatment in the related art such as a release treatment, an adhesiveness or adhesion improvement treatment, and an antistatic treatment. For example, by treating the back surface of the substrate with a release treatment agent, unwinding force of the pressure-sensitive adhesive sheet wound in a roll state can be reduced.

Examples of the release treatment agent include a silicone-based release treatment agent, a long-chain alkyl-based release treatment agent, an olefin-based release treatment agent, a fluorine-based release treatment agent, an aliphatic acid amide-based release treatment agent, molybdenum sulphide, and silica powder.

(Release Liner)

In the pressure-sensitive adhesive sheet according to the present embodiment, the pressure-sensitive adhesive layer may be protected by a release liner (separator, release film) until the pressure-sensitive adhesive sheet is used.

As the release liner, a common release paper or the like can be used and is not particularly limited, and for example, a substrate including a release treatment layer, a low adhesive substrate formed of a fluorine-based polymer, and a low adhesive substrate formed of a nonpolar polymer can be used.

Examples of the substrate including the release treatment layer include a plastic film or paper surface-treated with a release treatment agent such as a silicone-based release treatment agent, a long-chain alkyl-based release treatment agent, a fluorine-based release treatment agent, and molybdenum sulphide.

Examples of the fluorine-based polymer of the low adhesive substrate formed of a fluorine-based polymer include polytetrafluoroethylene, polychlorotrifluoroethylene, polyvinyl fluoride, polyvinylidene fluoride, a tetrafluoroethylene-hexafluoropropylene copolymer, and a chlorofluoroethylene-vinylidene fluoride copolymer.

Examples of the nonpolar polymer of the low adhesive substrate formed of a nonpolar polymer include olefin-based resins (for example, polyethylene, and polypropylene). The release liner can be formed by a known or common method. The thickness and the like of the release liner are also not particularly limited.

In a technique according to the present aspect, peel strength of the pressure-sensitive adhesive sheet measured by a method of Examples to be described later may be, for example, 0.5 N/25 mm or more, and usually 1 N/25 mm or more is suitable. From the viewpoint of improving bonding reliability, the peel strength is preferably, for example, 2 N/25 mm or more, and more preferably 5 N/25 mm or more.

In the technique according to the present aspect, a haze value of the pressure-sensitive adhesive sheet is appropriately about 10% or less, and may be about 5% or less (for example, about 3% or less). The haze value is preferably 1.0% or less. Such a highly transparent pressure-sensitive adhesive sheet is preferable in the present invention from the viewpoint of making the change in appearance significant when the pressure-sensitive adhesive sheet is discolored.

The haze value of the pressure-sensitive adhesive sheet may be less than 1.0%, may be less than 0.7%, or may be 0.5% or less (for example, 0 to 0.5%).

These haze values for the pressure-sensitive adhesive sheet may also be preferably applied to the haze value of the pressure-sensitive adhesive layer in the technique according to the present aspect.

Here, the “haze value” refers to a ratio of diffusively transmitted light to total transmitted light when a measurement object is irradiated with visible light. The haze value is also called a cloudiness value. The haze value can be expressed by the following formula.

Th[%]=Td/Tt×100

In the above formula, Th is the haze value [%], Td is scattering transmittance, and Tt is total light transmittance. The haze value can be measured according to a known method using a haze meter. The haze value can be adjusted by, for example, selecting a composition and a thickness of the pressure-sensitive adhesive layer.

The technique according to the present aspect can be preferably used, for example, for electronic member applications, optical member applications, building member applications, and the like.

<Method for Detecting Presence of Water or Water Vapor>

A method for detecting the presence of water or water vapor according to an embodiment of the present invention is characterized in that the above-described pressure-sensitive adhesive sheet is attached to the adherend, and the presence of the water or the water vapor at the attached location is detected. Preferably, the above-described pressure-sensitive adhesive sheet is attached so as to cover an assumed water leakage location of the adherend, thereby detecting leakage of the water or the water vapor at the attached location. Hereinafter, the leakage of the water or the water vapor may be simply referred to as “water leakage”.

According to the method of the present embodiment, it is possible to prevent (stop) water leakage from the attached location by attaching the pressure-sensitive adhesive sheet to a portion of the adherend where the water leakage is assumed in advance, and to detect the presence or leakage of the water or the water vapor by coloring the pressure-sensitive adhesive layer of the pressure-sensitive adhesive sheet when the water leaks.

The adherend is not particularly limited as long as the adherend is assumed to leak water, and includes various products. Examples thereof include automobiles, ships, aircrafts, railroad vehicles, buildings, household appliances, electronic devices, electrical appliances, water pipes and hoses, plumbing such as baths, toilets, and sinks, and partial components thereof (including components in a process of production).

The assumed water leakage location means a location where the water leakage is assumed or likely to occur in the adherend, and includes, for example, joints between members in the adherend, gaps (voids) on the product that is present at the time of product design, defects at the time of the product design, damaged locations during a use, and damaged/defective locations due to aged deterioration.

### EXAMPLES

Hereinafter, the embodiments of the present invention will be described in more detail using examples. In the examples, “parts” means parts by mass.

### Example 1

### [Preparation of Pressure-Sensitive Adhesive Composition]

A reaction vessel equipped with a condenser, a nitrogen introduction pipe, a thermometer, and a stirrer was charged with 65 parts of n-butyl acrylate (BA), 15 parts of N-vinyl-2-pyrrolidone (NVP), and 20 parts of 4-hydroxybutyl acrylate (4HBA) as monomer components, 0.1 parts of α-thioglycerol as a chain transfer agent, and 122 parts of ethyl acetate as a polymerization solvent, and 0.2 parts of azobisisobutyronitrile (AIBN) was added as a thermal polymerization initiator to carry out solution polymerization in a nitrogen atmosphere, and thus a solution containing an acrylic polymer A was obtained.

To the solution were added 1.2 parts of an isocyanate-based crosslinking agent (trade name “Takenate D110N”, manufactured by Mitsui Chemicals, Inc.), 0.01 parts of dioctyltin dilaurate (manufactured by Tokyo Fine Chemical CO., LTD., ENVILIZER OL-1, 1% by weight of ethyl acetate solution) as a crosslinking catalyst, and 5 parts of cobalt chloride dissolved in methanol with respect to 100 parts of the acrylic polymer A, and then defoaming was performed to obtain an acrylic pressure-sensitive adhesive composition.

[Preparation of Pressure-Sensitive Adhesive Sheet]

The obtained acrylic pressure-sensitive adhesive composition was applied using an applicator to a polyethylene terephthalate film (manufactured by Mitsubishi Chemical Corporation, product name “MRF #38”; first release liner) having a thickness of 38 μm and including one surface subjected to a release treatment with silicone, such that a thickness during drying is 50 μm, and thus a coating layer is was formed.

Next, the coating layer was placed in a dryer at 130° C. for 3 minutes to be dried, and after the coating layer was taken out from the dryer, a polyethylene terephthalate film (manufactured by Mitsubishi Chemical Corporation, product name “MRF #38”; second release liner) having a thickness of 38 μm and including one surface subjected to a release treatment with silicone was coated with the coating layer such that a release-treated surface was on a coating layer side to obtain a pressure-sensitive adhesive sheet of Example 1 having a thickness of 50 μm of the pressure-sensitive adhesive layer.

### Examples 2 to 4

Pressure-sensitive adhesive compositions and pressure-sensitive adhesive sheets of Examples 2 to 4 were obtained in the same manner as in Example 1 except that an addition amount of cobalt chloride was changed as shown in Table 1.

### Comparative Example 1

A pressure-sensitive adhesive composition and a pressure-sensitive adhesive sheet of Comparative Example 1 were obtained in the same manner as in Example 1 except that cobalt chloride was not used.

### Comparative Example 2

A pressure-sensitive adhesive composition and a pressure-sensitive adhesive sheet of Comparative Example 2 were obtained in the same manner as in Comparative Example 1 except that a solution containing an acrylic polymer was prepared as follows.

A reaction vessel equipped with a condenser, a nitrogen introduction pipe, a thermometer, and a stirrer was charged with 100 parts of n-butyl acrylate (BA) and 5 parts of acrylic acid (AA) as monomer components, and 122 parts of toluene as a polymerization solvent, and 0.2 parts of azobisisobutyronitrile (AIBN) was added as a thermal polymerization initiator to carry out solution polymerization in a nitrogen atmosphere, and thus a solution containing an acrylic polymer B was obtained.

<Compatibility of Water Discolorable Material>

In the pressure-sensitive adhesive compositions of the examples, the one in which cobalt chloride dissolved in methanol was compatible with the base pressure-sensitive adhesive (acrylic polymer A) was evaluated as “0”, and the one in which cobalt chloride dissolved in methanol was not compatible with the base pressure-sensitive adhesive (acrylic polymer A) was evaluated as “x”. The results are shown in Table 1. In Table 1, a pressure-sensitive adhesive composition of Comparative Example containing no cobalt chloride was denoted by “-”.

<Discoloration Test A>

One release liner (second release liner) of the obtained pressure-sensitive adhesive sheet was peeled, and the pressure-sensitive adhesive sheet was transferred to a PET film having a thickness of 50 μm (Lumirror S10 #50 manufactured by Toray Industries, Inc.) as a substrate using a hand roller to obtain a sample of a pressure-sensitive adhesive tape. The other release liner (first release liner) of the sample of the obtained pressure-sensitive adhesive tape was peeled, and the sample was stored in an environment of 40° C. and 92% RH in a state in which the pressure-sensitive adhesive layer was exposed, and a color change of the pressure-sensitive adhesive layer after 5 minutes was visually evaluated. The discolored ones were evaluated as ∘, and those not discolored were evaluated as x. The results are shown in Table 1.

<Discoloration Test B>

One release liner (second release liner) of the obtained pressure-sensitive adhesive sheet was peeled, and the pressure-sensitive adhesive sheet was transferred to a PET film having a thickness of 50 μm (Lumirror S10 #50 manufactured by Toray Industries, Inc.) as a substrate using a hand roller to obtain a sample of a pressure-sensitive adhesive tape. The other release liner (first release liner) of the sample of the obtained pressure-sensitive adhesive tape was peeled, an acrylic plate having a thickness of 1 mm and a through hole of 8 mmφ was pasted with the tape so as to cover the through hole, 300 μL of water was applied to the through hole from a surface of the acrylic plate to which the tape was not applied, and a color change of the pressure-sensitive adhesive layer after 5 minutes was visually evaluated. The discolored ones were evaluated as ∘, and those not discolored were evaluated as x. The results are shown in Table 1.

<Change in Light Transmittance in Discoloration Test A>

A release liner on one surface of the obtained pressure-sensitive adhesive sheet was released, and the pressure-sensitive adhesive sheet was attached to an alkali free glass substrate, and then a release liner on the other surface was released, and a transmission spectrum in a visible light region of 380 nm to 780 nm was measured with an ultraviolet-visible spectrophotometer (“U-4100” manufactured by Hitachi High-Tech Corporation). From the obtained transmission spectrum, minimum light transmittance at a wavelength of 600 nm or more and 700 nm or less before the discoloration test A was read. The results are shown in Table 1.

The sample after the discoloration test A was stored in an environment of 40° C. and 90% RH in a state in which the release liner on one side of the pressure-sensitive adhesive sheet sandwiched between the release liners on both sides was released to expose the pressure-sensitive adhesive layer on one side. After that, within 1 minute after taking out the sample from the storage environment, attaching to non-alkali glass and sample setting in the ultraviolet-visible spectrophotometer were completed, and the transmission spectrum in the visible light region from 380 nm to 780 nm was measured. From the obtained transmission spectrum, minimum light transmittance at a wavelength of 600 nm or more and 700 nm or less after the discoloration test A was read. The results are shown in Table 1. The one having minimum transmittance of 30% or less in the wavelength range

before the discoloration test A and minimum transmittance of 70% or more in the wavelength range after the discoloration test A was evaluated as ∘, and the one that did not satisfy the above conditions was evaluated as x. The results are shown in Table 1.

<180° Peeling Force>

The second release liner was peeled from the obtained pressure-sensitive adhesive sheet, and the pressure-sensitive adhesive sheet was attached to a PET film having a thickness of 100 μm which had been subjected to a corona treatment to prepare a single-sided pressure-sensitive adhesive sheet. This single-sided pressure-sensitive adhesive sheet was cut into a size of 25 mm in width and 100 mm in length to prepare a test piece.

In an environment of 23° C. and 50% RH, the first release liner was peeled from the test piece, and an exposed pressure-sensitive adhesive surface was press-bonded to a glass plate (Gorilla Glass 3, manufactured by Corning Inc.) as the adherend by reciprocating a 2-kg rubber roller once. This was subjected to an autoclave treatment (50° C., 0.5 MPa, and 15 minutes).

Thereafter, under an environment of 23° C. and 50% RH, the peel strength (180° peeling force) of the test piece from the glass plate was measured under conditions of a tensile speed of 300 mm/min and a peel angle of 180° by using a tensile tester (universal tensile and compression tester, device name “tensile compression tester, TCM-1kNB”, manufactured by Minebea Inc.). The measurement is performed three times, and an average value thereof is shown in Table 1.

TABLE 1
(Parts by weight)

| | | Example | Example | Example | Example | Comparative | Comparative |
|---|---|---|---|---|---|---|---|
| | | 1 | 2 | 3 | 4 | Example 1 | Example 2 |
| Pressure- | Acrylic | 100 | 100 | 100 | 100 | 100 | 0 |
| sensitive | polymer A | 0 | 0 | 0 | 0 | 0 | 100 |
| adhesive | Acrylic | | | | | | |
| | polymer B | | | | | | |
| Water | Cobalt | 5 | 10 | 30 | 50 | 0 | 0 |
| discolorable | chloride | | | | | | |
| material | | | | | | | |
| Compatibility of water | | ∘ | ∘ | ∘ | ∘ | — | — |
| discolorable material | | | | | | | |
| Minimum | Before | 19 | 15 | 9 | 2 | 92 | 91 |
| transmittance in | discoloration | | | | | | |
| wavelength range | test A | | | | | | |
| of 600 nm or | After | 80 | 78 | 75 | 72 | 92 | 91 |
| more and 700 nm | discoloration | | | | | | |
| or less [%] | test A | | | | | | |
| | Evaluation | ∘ | ∘ | ∘ | ∘ | x | x |

| | | | | | | |
|---|---|---|---|---|---|---|
| Discoloration test A | ∘ | ∘ | ∘ | ∘ | x | x |
| Discoloration test B | ∘ | ∘ | ∘ | ∘ | x | x |
| 180° peeling force [N/25 mm] | 11 | 10 | 6 | 2 | 12 | 10 |

From the results shown in Table 1, it is confirmed that the pressure-sensitive adhesive compositions of Examples have compatibility between the water discolorable material (cobalt chloride) and the acrylic polymer, and that the pressure-sensitive adhesive compositions were discolored with the water or the water vapor.

Further, the pressure-sensitive adhesive compositions of Examples exhibit sufficient peel strength even in the case of containing the water discolorable material.

When the pressure-sensitive adhesive compositions of Examples are used, the leakage of the water is not confirmed in any of the discoloration test A and the discoloration test B, and it is confirmed that the pressure-sensitive adhesive composition have a water stop function.

Although various embodiments have been described above with reference to the drawings, it goes without saying that the present invention is not limited to such examples. It is obvious that a person skilled in the art can conceive of various change examples or modifications within the scope described in the claims, and it is understood that these also belong to the technical scope of the present invention. Further, constituent elements in the above-described embodiment may be freely combined without departing from the gist of the invention.

The present application is based on a Japanese patent application (No. 2021-018308) filed on Feb. 8, 2021, contents of which are incorporated herein by reference.

### REFERENCE SIGNS LIST

20, 30 pressure-sensitive adhesive sheet
11, 21 pressure-sensitive adhesive layer
22, 32 substrate
31a first pressure-sensitive adhesive layer
31b second pressure-sensitive adhesive layer

1. A pressure-sensitive adhesive composition comprising:
a base polymer; and
a material that is discolored by water or water vapor.

2. The pressure-sensitive adhesive composition according to claim 1, further comprising:
a polar solvent.

3. The pressure-sensitive adhesive composition according to claim 2, wherein
the polar solvent contains at least one of an alcohol, a ketone, and an aromatic compound containing a nitrogen atom in a molecule.

4. The pressure-sensitive adhesive composition according to claim 1, wherein
the base polymer contains an acrylic polymer.

5. The pressure-sensitive adhesive composition according to claim 1, wherein
the material that is discolored by the water or the water vapor contains a transition metal compound capable of coordinating with a water molecule.

6. The pressure-sensitive adhesive composition according to claim 5, wherein
the transition metal compound capable of coordinating with the water molecule is cobalt chloride.

7. A pressure-sensitive adhesive sheet comprising:
a pressure-sensitive adhesive layer containing the pressure-sensitive adhesive composition according to claim 1.

8. The pressure-sensitive adhesive sheet according to claim 7, wherein
the pressure-sensitive adhesive layer is provided on a substrate.

9. The pressure-sensitive adhesive sheet according to claim 7, which is configured to:
detect leakage of the water or the water vapor from an assumed water leakage location.

10. A method for producing a pressure-sensitive adhesive composition containing a base polymer and a material that is discolored by water or water vapor, the method comprising:
dissolving, in a polar solvent, the material that is discolored by the water or the water vapor; and
adding, to a base polymer solution, the material that is discolored by the water or the water vapor which is dissolved in the polar solvent.

11. A method for attaching the pressure-sensitive adhesive sheet according claim 7 to an adherend and detecting presence of the water or the water vapor in the attached location.
